(19) United States
(12) Patent Application Publication
(10) Pub. No.: US 2026/0156414 A1
(43) Pub. Date: Jun. 4, 2026

(54) WEARABLE DEVICE AND METHOD FOR ACQUIRING VOICE SIGNAL BASED ON WEARING STATE

(71) Applicant: SAMSUNG ELECTRONICS CO., LTD., Suwon-si (KR)

(72) Inventors: Sangwoo YU, Suwon-si (KR); Hyeonyeong JEONG, Suwon-si (KR); Yongbum JEUNG, Suwon-si (KR); Seunga LEE, Suwon-si (KR); Haekeu PARK, Suwon-si (KR); Lockhee KANG, Suwon-si (KR); Sohee KIM, Suwon-si (KR)

(73) Assignee: SAMSUNG ELECTRONICS CO., LTD., Suwon-si (KR)

(21) Appl. No.: 19/458,059

(22) Filed: Jan. 23, 2026

Related U.S. Application Data
(63) Continuation of application No. PCT/KR2024/007334, filed on May 29, 2024.

(30) Foreign Application Priority Data
Jul. 25, 2023 (KR) 10-2023-0097086
Aug. 17, 2023 (KR) 10-2023-0107953

(51) Int. Cl. H04R 5/04; H04R 3/04; H04R 5/033

(52) U.S. Cl. CPC H04R 5/04; H04R 3/04; H04R 5/033; H04R 2420/07

(57) ABSTRACT

An earbud includes a speaker, a communication circuit, multiple microphones, an acceleration sensor, and at least one processor. The earbud is configured to receive, from an external electronic device, a first data signal for identifying at least one filter among multiple filters for audio data output from the multiple microphones. The earbud is configured to identify at least one microphone for mono recording among the multiple microphones based on reception of the first data signal. The earbud is configured to obtain voice data by applying a filter for the mono recording among the multiple filters to a voice signal received from the at least one microphone. The earbud is configured to transmit a second data signal indicating the voice data to the external electronic device.

### CROSS-REFERENCE TO RELATED APPLICATIONS

This application is a continuation of International Application No. PCT/KR 2024/007334, filed on May 29, 2024, which is based on and claims priority to Korean Patent Application No. 10-2023-0097086, filed on Jul. 25, 2023, and Korean Patent Application No. 10-2023-0107953, filed on Aug. 17, 2023, in the Ministry of Intellectual Property, the disclosures of which are incorporated by reference herein in their entireties.

### BACKGROUND

### 1. Field

The disclosure relates to a wearable device and a method for obtaining a voice signal based on a wearing state.

### 2. Description of Related Art

An electronic device (e.g., earbuds) may be used in order to output an audio signal. While outputting the audio signal, the electronic device may perform noise canceling functions (e.g., active noise canceling (ANC)) or a mono recording function using a microphone and a speaker to remove a noise signal. The electronic device may identify (or detect) a wearing state using a sensor. The electronic device may control at least one function based on the wearing state.

The above-described information may be provided as a related art for the purpose of helping understanding of the disclosure. No argument or determination is made as to whether any of the above description may be applied as a prior art related to the disclosure.

A first earbud according to an embodiment may include a speaker, a communication circuit, a plurality of microphones, an acceleration sensor, at least one processor including a processing circuit, and memory 120 including one or more storage media storing instructions. The instructions, based on being executed by the at least one processor, individually or collectively, may cause the first earbud to receive a first data signal from an external electronic device to identify at least one of a plurality of filters for audio data output from the plurality of microphones. The plurality of filters may include a filter for mono recording in a state in which the first earbud and a second earbud paired with the first earbud are worn by different users. The instructions, based on being executed by the at least one processor, individually or collectively, may cause the first earbud to identify at least one microphone for the mono recording among the plurality of microphones based on receiving the first data signal. The instructions, based on being executed by the at least one processor, individually or collectively, may cause the first earbud to obtain voice data by applying the filter for the mono recording among the plurality of filters to a voice signal received through the at least one microphone. The instructions, based on being executed by the at least one processor, individually or collectively, may cause the first earbud to transmit a second data signal indicating the voice data to the external electronic device.

An electronic device according to an embodiment may include a communication circuit, at least one processor including a processing circuit, memory 120-1 including one or more storage media storing instructions. The instructions, based on being executed by the at least one processor, individually or collectively, may cause the electronic device to transmit a first data signal for performing recording to a plurality of wearable devices forming a pair connected through the communication circuit. The instructions, based on being executed by the at least one processor, individually or collectively, may cause the electronic device to receive first audio data of a first wearable device among the plurality of wearable devices and second audio data of a second wearable device among the plurality of wearable devices, based on transmitting the first data signal. The instructions, based on being executed by the at least one processor, individually or collectively, may cause the electronic device to identify a phase difference between first audio data received from the first wearable device and second audio data received from the second wearable device exceeding a threshold range. The instructions, based on being executed by the at least one processor, individually or collectively, may cause the electronic device to identify a state of the plurality of wearable devices worn by different users based on identifying the phase difference exceeding the threshold range. The instructions, based on being executed by the at least one processor, individually or collectively, may cause the electronic device to transmit a third data signal requesting to obtain voice data by applying a filter for mono recording to the plurality of wearable devices, based on identifying the state.

A method of an electronic device according to an embodiment may include transmitting a first data signal for performing recording to a plurality of wearable devices forming a pair connected through a communication circuit. The method may include receiving first audio data of a first wearable device among the plurality of wearable devices and second audio data of a second wearable device among the plurality of wearable devices, based on transmitting the first data signal. The method may include identifying a phase difference between first audio data received from the first wearable device and second audio data received from the second wearable device exceeding a threshold range. The method may include identifying a state of the plurality of wearable devices worn by different users based on identifying the phase difference exceeding the threshold range. The method may include transmitting a third data signal requesting to obtain voice data by applying a filter for mono recording to the plurality of wearable devices, based on identifying the state.

In a computer readable storage medium storing one or more programs, the one or more programs may be configured to, based on being executed by at least one processor of a first earbud, cause the first earbud to receive a first data signal from an external electronic device to identify at least one of a plurality of filters applicable to audio data output from a plurality of microphones. The plurality of filters may include a filter for mono recording in a state in which the first earbud and a second earbud paired with the first earbud are worn by different users. The one or more programs may be configured to, based on being executed by the at least one processor, cause the first earbud to identify at least one microphone for the mono recording among the plurality of microphones based on receiving the first data signal. The one or more programs may be configured to, based on being executed by the at least one processor, cause the first earbud to obtain voice data by applying the filter for the mono recording among the plurality of filters to a voice signal received through the at least one microphone. The one or more programs may be configured to, based on being executed by the at least one processor, cause the first earbud to transmit a second data signal indicating the voice data to the external electronic device.

In a computer readable storage medium storing one or more programs, the one or more programs may be configured to, based on being executed by at least one processor of an electronic device including a communication circuit and the at least one processor, cause the electronic device to transmit a first data signal for performing recording to a plurality of wearable devices forming a pair connected through the communication circuit. The one or more programs may be configured to, based on being executed by the at least one processor, cause the electronic device to receive first audio data of a first wearable device among the plurality of wearable devices and second audio data of a second wearable device among the plurality of wearable devices, based on transmitting the first data signal. The one or more programs may be configured to, based on being executed by the at least one processor, cause the electronic device to identify a phase difference between first audio data received from the first wearable device and second audio data received from the second wearable device exceeding a threshold range. The one or more programs may be configured to, based on being executed by the at least one processor, identify a state of the plurality of wearable devices worn by different users based on identifying the phase difference exceeding the threshold range. The at least one processor may be configured to cause the electronic device to transmit a third data signal requesting to obtain voice data by applying a filter for mono recording to the plurality of wearable devices, based on identifying the state.

### BRIEF DESCRIPTION OF THE DRAWINGS

FIG. 1 is a block diagram of a wearable device and an electronic device according to an embodiment.

FIG. 2A is a perspective view of a wearable device.

FIG. 2B is an exploded view of a wearable device.

FIG. 3 is a flowchart illustrating an operation of an electronic device according to an embodiment.

FIGS. 4A and 4B illustrate an example of a wearing state of a wearable device according to an embodiment.

FIG. 5 is a flowchart illustrating an operation of a wearable device according to an embodiment.

FIG. 6 is a block diagram illustrating functions performed according to a wearing state of a wearable device according to an embodiment.

FIG. 7 is a block diagram illustrating an example of a signal flow diagram between a wearable device and an electronic device according to an embodiment.

FIG. 8 illustrates an example of an operation in which a wearable device according to an embodiment obtains a voice signal from each of different users.

FIG. 9 is a block diagram of an electronic device in a network environment according to various embodiments.

### DETAILED DESCRIPTION

Hereinafter, an embodiment of the disclosure will be described in detail with reference to the drawings such that it may readily implemented. However, the disclosure may be implemented in various different forms and is not limited to an embodiment described herein. Regarding a description of the drawings, the same or similar reference numerals may be used for the same or similar components. In addition, in the drawings and the related description, descriptions for well-known functions and configurations may be omitted for clarity and conciseness.

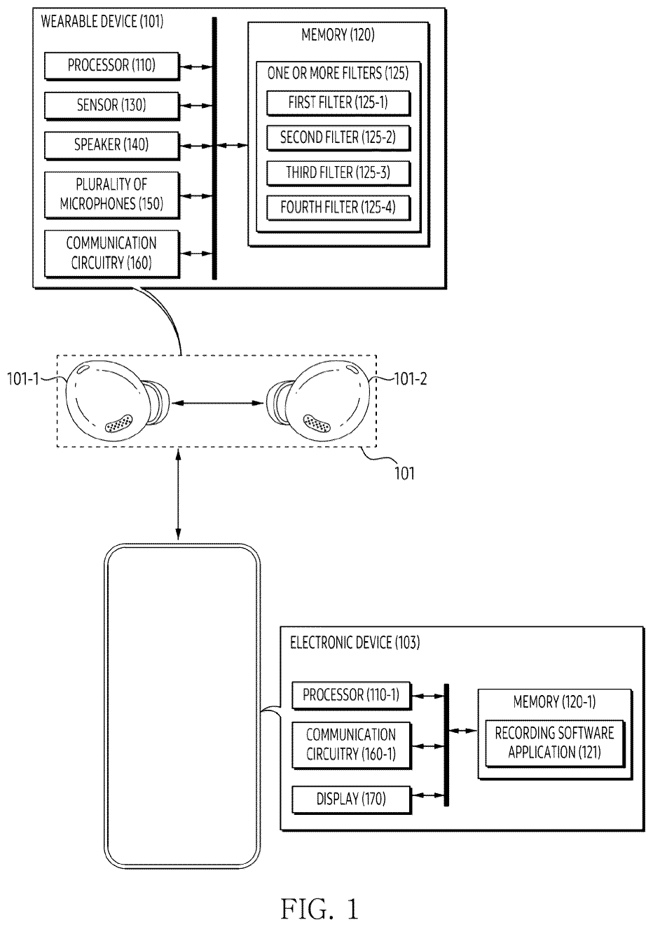

FIG. 1 illustrates an example of a block diagram of a wearable device and an electronic device according to an embodiment. Referring to FIG. 1, an example of an interaction between a plurality of electronic devices 101 and 103 is illustrated. A wearable device 101 and an external electronic device 103 (e.g., a smartphone) according to an embodiment may interact (or communicate) with each other via wired and/or wireless communication. For example, the wearable device 101 may be an audio sink device such as a pair of earbuds or earphones. For example, the external electronic device 103 may be an audio source device such as a smartphone, a laptop computer, a tablet PC, or a smartwatch.

The wearable device 101 according to an embodiment may be configured as a pair of earbuds or earphones. For example, the wearable device 101 may include a first earbud 101-1 and a second earbud 101-2 forming a pair with the first earbud 101-1. The first earbud 101-1 and the second earbud 101-2 may be configured as a pair. For example, a housing of the first earbud 101-1 may have a form attachable to a left auricle of a user. For example, a housing of the second earbud 101-2 may be attachable to a right auricle of a user. The wearable device 101 may include canal-type earbuds and/or open-type earbuds.

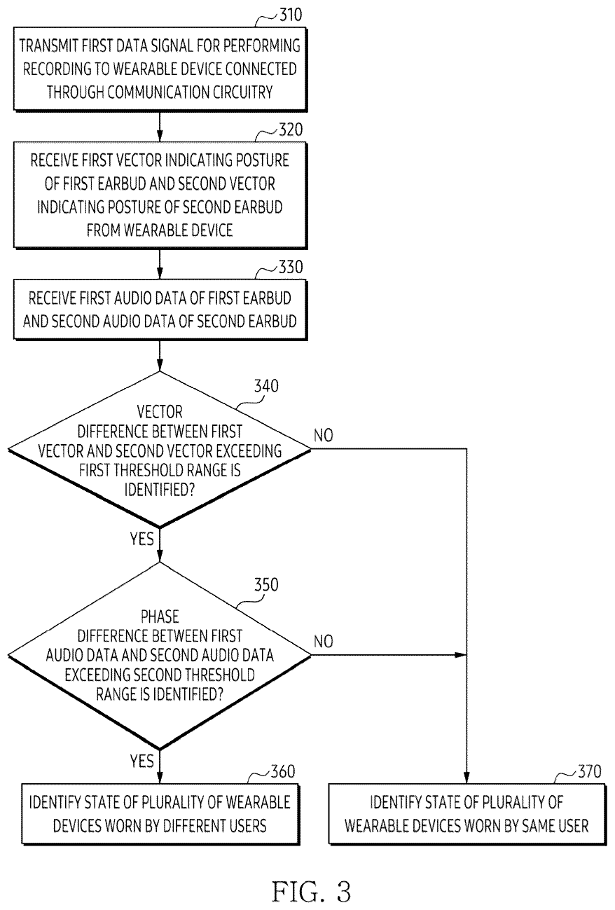

The wearable device 101 according to an embodiment may identify (or detect) a level (or degree) of contact with an external object (e.g., the user) based on sensing information obtained from a sensor included in the wearable device 101. For example, the level of contact may represent a probability or likelihood that the external object is spaced apart from the wearable device 101. As used herein, the term “level of contact” (or “degree of contact”) as used herein may represent a magnitude, pattern, or condition of physical contact between the wearable device and the user, and may be determined using one or more types of sensing information (e.g., pressure, capacitance, optical reflectance, inertial data, or skin detection signals). For example, the wearable device 101 may identify (or detect) a posture of the first earbud 101-1 and a posture of the second earbud 101-2 in a state of being in contact with the external object. A posture of the wearable device 101 including the first earbud 101-1 and the second earbud 101-2 may be identified based on a form and/or a position in which the wearable device 101 is in contact with the external object (e.g., the user) and/or a direction in which a portion of the wearable device 101 faces. The wearable device 101 may identify (or detect) a wearing state of the wearable device 101 based on the posture of the wearable device 101 identified using the sensor. For example, the wearing state may be identified based on information received from the external electronic device 103 to the wearable device 101. An operation in which the wearable device 101 receives the wearing state of the wearable device 101 from the external electronic device 103, by using information indicating the posture (e.g., the posture of the first earbud 101-1 and the posture of the second earbud 101-2) of the wearable device 101 will be described later with reference to FIG. 3.

The wearable device 101 according to an embodiment may establish a communication link with the external electronic device 103 using a communication circuit 160. For example, at least one of the first earbud 101-1 and the second earbud 101-2 may establish the communication link with the external electronic device 103. An operation in which the wearable device 101 obtains audio data via the communication link may include sniffing (or snooping). The sniffing may mean, for example, an operation in which the second earbud 101-2 accesses a communication link between other electronic devices (e.g., the first earbud 101-1 and the external electronic device 103) and obtains data transmitted or received via the communication link. The second earbud 101-2 may output at least a portion of the obtained (or sniffed) audio data as an audio signal. Hereinafter, an operation performed by the wearable device 101 may be performed by at least one of the first earbud 101-1 and the second earbud 101-2.

For example, the first earbud 101-1 may establish a communication link with the second earbud 101-2. The communication link established between the first earbud 101-1 and the second earbud 101-2 may be used so that the first earbud 101-1 may receive information for the obtaining (or the sniffing) of audio data or additional information on audio data. For example, via the communication link established between the first earbud 101-1 and/or the second earbud 101-2, the second earbud 101-2 may transmit data on the posture of the second earbud 101-2 to the first earbud 101-1. However, embodiments are not limited thereto.

For example, the first earbud 101-1 and the second earbud 101-2 may establish a communication link with the external electronic device 103, respectively. The first earbud 101-1 may transmit information (e.g., a vector value) indicating the posture of the first earbud 101-1 to the external electronic device 103 via the communication link established with the external electronic device 103. The second earbud 101-2 may transmit information indicating the posture of the second earbud 101-2 to the external electronic device 103 via the communication link established with the external electronic device 103.

The external electronic device 103 according to an embodiment may transmit audio data being played in the external electronic device 103 to the wearable device 101. For example, the data may be usable in the wearable device 101 to output audio from the wearable device 101. In terms of being able to control at least a portion of functions of the wearable device 101, the external electronic device 103 may be referred to as a primary device or master device.

For example, based on receiving audio data from the external electronic device 103, the wearable device 101 may output the audio data through a speaker 140 of the wearable device 101. For example, the wearable device 101 may be referred to as a secondary (or slave) device.

According to an embodiment, the wearable device 101 may include at least one of a processor 110, a memory 120, a sensor 130, the speaker 140, a plurality of microphones 150, or the communication circuit 160. The processor 110, the memory 120, the sensor 130, the speaker 140, the plurality of microphones 150, and the communication circuit 160 may be electronically and/or operably coupled with each other by an electronic component, such as a communication bus. Although illustrated based on different blocks, an embodiment is not limited thereto. A type and/or the number of hardware components included in the wearable device 101 is not limited to those illustrated in the block diagram of FIG. 1. For example, the wearable device 101 may include only some of hardware exemplified based on the block diagram of FIG. 1.

According to an embodiment, the processor 110 of the wearable device 101 may include a hardware component for processing data based on one or more instructions. The hardware component for processing data may include, for example, an arithmetic and logic unit (ALU), a floating point unit (FPU), a field programmable gate array (FPGA), an application processor (AP), and/or a central processing unit (CPU). The number of processors 110 may be one or more. For example, the processor 110 may have a structure of a multi-core processor, such as a dual-core processor, a quad-core processor, or a hexa-core processor.

According to an embodiment, the memory 120 of the wearable device 101 may include a hardware component for storing data and/or instructions inputted to and/or output from the processor 110. The memory 120 may include, for example, volatile memory, such as random-access memory (RAM), and/or non-volatile memory, such as read-only memory (ROM). The volatile memory may include, for example, at least one of dynamic RAM (DRAM), static RAM (SRAM), cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disc, or an embedded multimedia card (eMMC).

According to an embodiment, the sensor 130 of the wearable device 101 may generate electronic information that is processed by the processor 110 and/or memory from non-electronic information related to the wearable device 101. The electronic information generated by the sensor 130 may be stored in the memory 120, processed by the processor 110, and/or transmitted to another electronic device (e.g., the external electronic device 103) that is distinct from the wearable device 101. An embodiment of the wearable device 101 is not limited to a type and/or the number of sensors described with reference to FIG. 3. As an example, the wearable device 101 may further include a pressure sensor for detecting pressure.

According to an embodiment, the wearable device 101 may perform various operations based on information obtained using the sensor 130. For example, the wearable device 101 may identify (or detect) whether it is worn on and is in a state close to a part of the user's body from the information obtained from the sensor 130. For example, the wearable device 101 may identify (or detect) whether a detachable status is changed from the information obtained from the sensor 130. For example, the wearable device 101 may obtain physical data using the sensor 130 (e.g., a proximity sensor). For example, the sensor 130 may obtain data related to a level at which the wearable device 101 is in contact with the external object (e.g., the user). The processor 110 receiving the data obtained by the sensor 130 may identify (or detect) an external object in contact with the wearable device 101 based on the data. For example, the sensor 130 may identify (or detect) contact with the external object using at least one light. For example, the proximity sensor may identify (or detect) contact with the external object using at least one signal.

The wearable device 101 according to an embodiment may identify (or detect) movement of the wearable device 101 using the sensor 130 (e.g., an acceleration sensor). The processor 110 receiving data obtained by the acceleration sensor may identify (or detect) the position, the posture, and/or the movement of the wearable device 101 based on the data. For example, the wearable device 101 may identify (or detect) acceleration using the acceleration sensor. The acceleration may be a vector based on a direction and/or magnitude of a net force applied to the wearable device 101. For example, the acceleration may be a vector indicating an amount of change in speed of the wearable device 101 by the net force. The net force applied to the wearable device 101 may include gravity or a combination of another force distinct from the gravity. For example, the acceleration sensor of the wearable device 101 may identify (or detect) rotation of the acceleration sensor based on one or more axes (e.g., three axes). For example, the acceleration sensor included in the wearable device 101 may be one or more. For example, the acceleration sensor may include a gyro sensor. The acceleration sensor including the gyro sensor may identify (or detect) the rotation based on one or more axes (e.g., six axes). According to an embodiment, the wearable device 101 may identify (or detect) the posture of the wearable device 101 based on the acceleration and/or the rotation identified by each of the acceleration sensors.

For example, the wearable device 101 may identify (or detect) the wearing state of the wearable device 101 based on identifying the posture of the wearable device 101 using the acceleration sensor. The wearable device 101 may transmit information indicating the posture of the wearable device 101 to the external electronic device 103. The external electronic device 103 may transmit information indicating the wearing state corresponding to the posture to the wearable device 101 based on reception of the information. The wearing state may include a state in which the first earbud 101-1 and the second earbud 101-2 included in the wearable device 101 are worn by the same user. The wearing state may include a state in which the first earbud 101-1 and the second earbud 101-2 are worn by different users.

For example, the wearable device 101 may initiate execution of at least one function based on the identified wearing state. For example, the at least one function may be one of a call function, a recording function (e.g., mono recording or binaural recording), an active noise cancellation (ANC) function, and/or an ambient sound listening function. For example, by initiating execution of the at least one function, the wearable device 101 may transmit data related to audio (e.g., data indicating a voice signal) according to the wearing state to the external electronic device 103 or receive it from the external electronic device 103.

The wearable device 101 according to an embodiment may identify (or detect) presence or absence of a touch input using the sensor 130 (e.g., a touch sensor). For example, the sensor 130 may identify (or detect) a pressure of the touch input received by the wearable device 101. The sensor 130 may convert a measured or detected touch input into an electrical signal. The processor 110 receiving data obtained by the sensor 130 may identify (or detect) a type of the touch input based on the data. For example, the touch input may include a tap input, a double tap input, and/or a long press input in which an input is maintained for a specified time.

The speaker 140 according to an embodiment may output an audio signal. For example, the wearable device 101 may receive audio data from an external device (e.g., the external electronic device 103, a server, a smartphone, a PC, a PDA, or an access point). The wearable device 101 may output the received audio data using the speaker 140. For example, the speaker 140 may receive an electrical signal. For example, the speaker 140 may convert an electrical signal into a sound wave signal. For example, the speaker 140 may output an audio signal including the converted sound wave signal.

The plurality of microphones 150 of the wearable device 101 according to an embodiment may receive another audio signal different from an audio signal received from the external electronic device 103. For example, the wearable device 101 may include one or more microphones. For example, the wearable device 101 may dispose the plurality of microphones 150 in a portion of a housing of the wearable device 101. The plurality of microphones 150 may be referred to as a feedback microphone in terms of being disposed adjacent to a speaker. For example, the plurality of microphones 150 may be disposed in a portion of the housing including a sensor (e.g., the sensor 130) of the wearable device 101. The plurality of microphones 150 may be referred to as a feedforward microphone in terms of being disposed toward the outside of the wearable device 101. However, embodiments are not limited thereto.

The wearable device 101 according to an embodiment may receive a voice signal using the plurality of microphones 150. For example, the wearable device 101 may perform preprocessing to change the received voice signal into voice data. For example, based on performing the preprocessing, the wearable device 101 may obtain the voice data to be transmitted to the external electronic device 103. For example, the preprocessing for the voice signal may include at least one of filtering, Fourier transform, cancellation of a component within a specific frequency band, or a feature extractor scheme. Through the preprocessing of the voice signal, the wearable device 101 may obtain voice data in which a voice portion of the voice signal is enhanced. Through the preprocessing of the voice signal, the wearable device 101 may obtain voice data in which a noise portion of the voice signal is suppressed or cancelled.

The communication circuit 160 of the wearable device 101 according to an embodiment may include hardware for supporting transmission and/or reception of an electrical signal between the wearable device 101 and the external electronic device 103. The wearable device 101 may establish a communication link with the external electronic device 103 through the communication circuit 160. The communication circuit 160 may include, for example, at least one of a modulator and demodulator (MODEM), an antenna, or an optic/electronic (O/E) converter. The communication circuit 160 may support transmission and/or reception of an electrical signal based on various types of wireless communication protocols, such as Ethernet, a local area network (LAN), a wide area network (WAN), wireless fidelity (WiFi), Bluetooth, Bluetooth low energy (BLE), Bluetooth low energy audio (LE Audio), ZigBee, long term evolution (LTE), and 5G new radio (5G NR). The communication link is not limited to the above-described wireless communication protocols, and may be established by a wired communication protocol, such as a universal serial bus (USB), and/or a dedicated protocol for communication between the wearable device 101 and the external electronic device 103.

For example, the wearable device 101 may receive a data signal for recording from the external electronic device 103 using the communication circuit 160. The wearable device 101 may obtain a voice signal by using at least one of the plurality of microphones 150 of the wearable device 101 in response to the received data signal. Based on receiving the data signal, the wearable device 101 may transmit voice data corresponding to the voice signal to the external electronic device 103. Based on receiving the data signal, the wearable device 101 may transmit the information indicating the posture of the wearable device 101. The wearable device 101 may receive information indicating the wearing state of the wearable device 101 from the external electronic device 103. Based on receiving the information indicating the wearing state, the wearable device 101 may determine a filter to be used for performing preprocessing for the voice signal. For example, based on receiving the information indicating the wearing state, the wearable device 101 may select a microphone for obtaining the voice signal among the plurality of microphones 150. Based on receiving the information indicating the wearing state, the wearable device 101 may obtain the voice signal using sensing data (e.g., data indicating vibration) through a sensor.

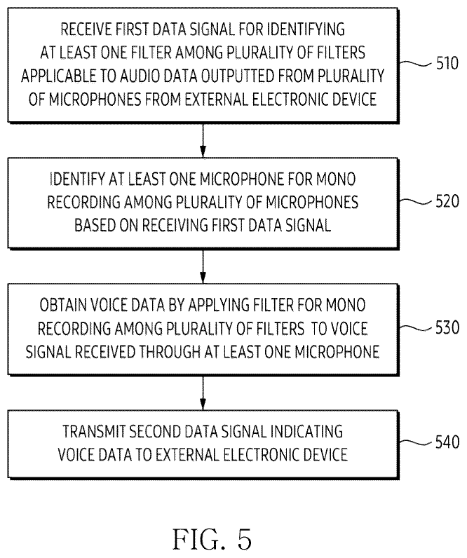

According to an embodiment, one or more instructions (or commands) indicating a calculation and/or an operation to be performed on data by the processor 110 may be stored in the memory 120 of the wearable device 101. A set of one or more instructions may be referred to as firmware, an operating system, a process, a routine, a sub-routine, and/or an application. For example, when a set of a plurality of instructions distributed in a form of an operating system, firmware, a driver, and/or an application is executed, the wearable device 101 and/or the processor 110 may perform at least one of the operations of FIG. 5.

The memory 120 of the wearable device 101 according to an embodiment may include one or more filters 125 corresponding to each of one or more functions that is performed by the wearable device 101. The one or more filters 125 may include operators and/or layers used to perform each of the one or more functions. For example, the one or more filters 125 may be used to post-process data processed in the wearable device 101. The one or more filters 125 may be processed by a digital signal processor (DSP). The wearable device 101 may process data on audio using a filter related to at least one function while performing the at least one function.

For example, the wearable device 101 may change the voice signal received through at least one microphone among the plurality of microphones 150 into voice data using a first filter 125-1. The wearable device 101 may obtain voice data in which a noise portion included in the voice signal is cancelled or a voice portion included in the voice signal is enhanced using the first filter 125-1. The first filter 125-1 may be related to a function for performing mono recording. The first filter 125-1 may be referred to as a voice band compensation filter in terms of enhancing a bandwidth corresponding to the user's voice.

For example, the wearable device 101 may adjust a phase of an input signal received by the wearable device 101 using a second filter 125-2 related to binaural recording (or stereoscopic sound recording and 360-degree recording). The wearable device 101 may obtain an output signal from the input signal using the second filter 125-2 based on information on a direction of sound corresponding to the input signal. The input signal may be obtained through a microphone of the wearable device 101 or provided from the external electronic device 103. The output signal may be output through a speaker of the wearable device 101 or provided to the external electronic device 103. However, embodiments are not limited thereto.

For example, the wearable device 101 may generate a tuning signal corresponding to the input signal received by the wearable device 101 using a third filter 125-3 related to the ANC function. The tuning signal may be generated based on another phase opposite to the phase of the input signal. The wearable device 101 may generate a tuning signal for a noise portion included in the input signal. The wearable device 101 may obtain an output signal in which the noise portion is cancelled from the input signal through the third filter 125-3.

For example, the wearable device 101 may change a voice signal received by at least one of the plurality of microphones 150 using a fourth filter 125-4 related to the call function. The wearable device 101 may obtain voice data in which a voice portion included in the voice signal is enhanced through the fourth filter 125-4. However, embodiments are not limited thereto.

Referring to FIG. 1, an example of a block diagram of the external electronic device 103 connectable to the wearable device 101 according to an embodiment is illustrated. The external electronic device 103 may include at least one of a processor 110-1, memory 120-1, a communication circuit 160-1, or a display 170. The processor 110-1, the memory 120-1, the communication circuit 160-1, and the display 170 may be electronically and/or operably coupled with each other by a communication bus in the external electronic device 103. The processor 110-1, the communication circuit 160-1, and the memory 120-1 of the external electronic device 103 may perform functions substantially similar to those of the processor 110, the communication circuit 160, and the memory 120 of the wearable device 101. Hereinafter, overlapping descriptions may be omitted to reduce repetition.

According to an embodiment, the display 170 of the external electronic device 103 may output visualized information to the user. The number of displays 170 included in the external electronic device 103 may be one or more. For example, the display 170 may output visualized information to the user by being controlled by the processor 110-1 and/or a graphic processing unit (GPU) of the external electronic device 103. The display 170 may include a flat panel display (FPD) and/or electronic paper. The FPD may include a liquid crystal display (LCD), a plasma display panel (PDP), a digital mirror device (DMD), one or more light emitting diodes (LEDs), and/or a micro LED. The LED may include an organic LED (OLED).

According to an embodiment, one or more instructions (or commands) indicating a calculation and/or an operation to be performed on data by the processor 110-1 may be stored in the memory 120-1 of the external electronic device 103. A set of one or more instructions may be referred to as firmware, an operating system, a process, a routine, a sub-routine, and/or an application. For example, when a set of a plurality of instructions distributed in a form of an operating system, firmware, a driver, and/or an application is executed, the external electronic device 103 and/or the processor 110-1 may perform at least one of the operations of FIG. 3. Hereinafter, an application being installed on the external electronic device 103 may mean that one or more instructions provided in a form of an application are stored in the memory 120-1 of the external electronic device 103 and that the one or more applications are stored in a format (e.g., a file having an extension specified by an operating system of the external electronic device 103) executable by the processor 110-1 of the external electronic device 103.

The external electronic device 103 according to an embodiment may record voice data received by the external electronic device 103 based on execution of a recording software application 121. The voice data may be received through a microphone of the external electronic device 103 or received from the wearable device 101. The recording software application 121 may include a software application for recording audio and/or video. In a state of being connected to the wearable device 101, the external electronic device 103 may transmit a data signal indicating performance of recording to the wearable device 101 based on the execution of the recording software application 121. Based on transmitting the data signal, the external electronic device 103 may obtain the voice data from the wearable device 101. However, embodiments are not limited thereto.

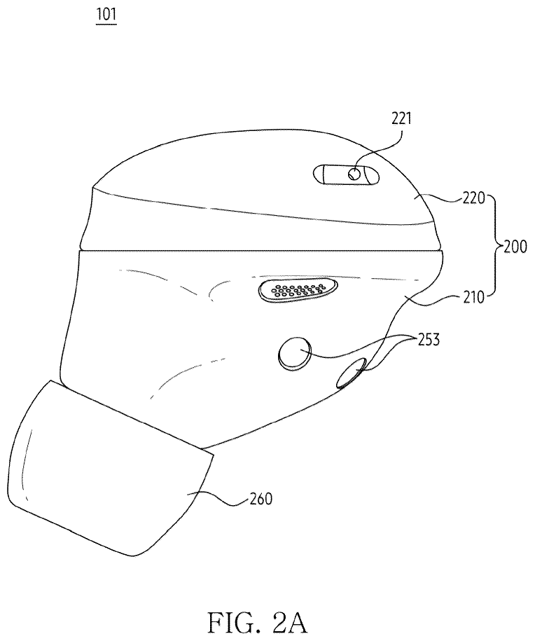

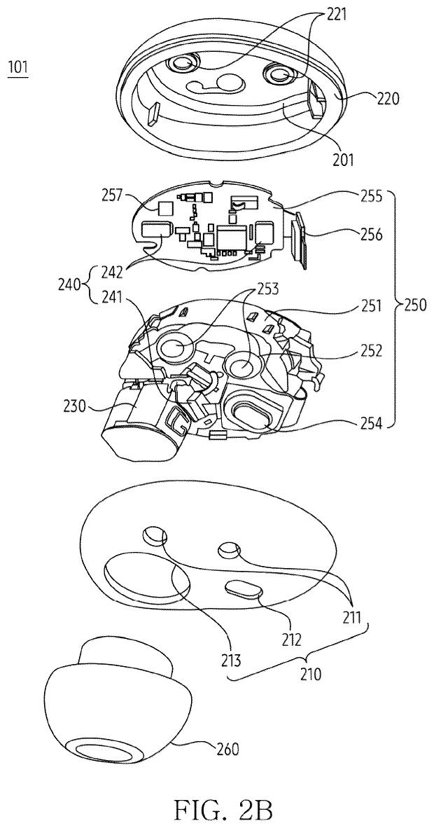

FIG. 2A illustrates an example of a perspective view of a wearable device. FIG. 2B illustrates an example of an exploded view of a wearable device. For example, a wearable device 101 of FIGS. 2A and 2B may indicate an example of the wearable device 101 of FIG. 1. Descriptions of the wearable device 101 of FIGS. 2A and 2B may include descriptions of the first earbud 101-1 and the second earbud 101-2 configuring a pair of FIG. 1.

Referring to FIGS. 2A and 2B, the wearable device 101 may include a case 200 and/or an ear tip 260.

According to an embodiment, the wearable device 101 may be worn on a part (e.g., a head or an ear) of a user's body to provide audio information to the user. For example, the wearable device 101 may provide audio information to the user by inserting a portion into the user's ear. A partial area of the wearable device 101 including the ear tip 260 may be inserted into the user's ear and may transmit audio information provided from a sound output device disposed inside the wearable device 101 to the user through the ear tip 260. For example, the wearable device 101 may include true wireless stereo (TWS). According to an embodiment, the wearable device 101 may provide audio information to a user wearing the wearable device 101 based on a signal received from an external device. For example, the wearable device 101 may receive a signal related to audio information from an external electronic device (e.g., a portable communication device (e.g., a smartphone), a computer device, a portable multimedia device, a portable medical device, a camera, another wearable device, or a home appliance) (e.g., the external electronic device 103). The wearable device 101 may establish a communication channel with the external electronic device 103 and may receive not only the signal related to the audio information but also a control signal for controlling the wearable device 101 from the external electronic device.

According to an embodiment, the wearable device 101 may include a communication module (e.g., the communication circuit 160 of FIG. 1) for communicating with an external device. The wearable device 101 may control an operation of internal configurations based on a signal received through the communication module. For example, the communication module may be a communication module for Bluetooth, but embodiments are not limited thereto. For example, the communication module may communicate with an external electronic device through a short-range communication network. In an embodiment, the wearable device 101 may be connected to an external electronic device by wire. For example, the wearable device 101 may be connected to an interface of an external electronic device through a cable connected to the wearable device 101.

For example, the signal related to the audio information may include a signal related to music or voice to be provided to the user by the wearable device 101. For example, the control signal (or a data signal) may include a signal for adjusting a sound of the wearable device 101 or requesting an update of software installed on the wearable device 101. For example, the wearable device 101 may receive data for updating software.

The case 200 according to an embodiment may form an outer surface that the user's hand may contact. According to an embodiment, the case 200 may form an inner space 201 in which various configurations of the wearable device 101 may be accommodated. According to an embodiment, the case 200 may include a first case 210 and/or a second case 220. For example, the inner space 201 may be a space surrounded by the first case 210 and the second case 220 by coupling of the first case 210 and the second case 220. The inner space 201 may further include mechanisms (e.g., a bracket) capable of supporting electronic components, which are configurations of the wearable device 101.

According to an embodiment, when the user wears the wearable device 101, the first case 210 may be disposed to face an external auditory canal of the user. According to an embodiment, a terminal hole 211 connecting a terminal 253 and the outside of the wearable device 101 may be formed on a side of the first case 210. The terminal 253 may be exposed to the outside of the first case 210 through the terminal hole 211. According to an embodiment, the first case 210 may include a sensor hole 212 connecting a wearing detection sensor 254 and the outside of the wearable device 101. The wearing detection sensor 254 may be a sensor capable of collecting information that detects wearing by the user. The wearing detection sensor 254 may be exposed to the outside of the first case 210 through the sensor hole 212. According to an embodiment, the first case 210 may include a through hole 213 connecting the inner space 201 and the outside of the wearable device 101.

When the user wears the wearable device 101, the second case 220 may be disposed to face a direction opposite to a direction in which the first case 210 is disposed based on a boundary surface between the first case 210 and the second case 220. According to an embodiment, a microphone hole 221 connecting the outside of the wearable device 101 and the inner space 201 in which a microphone 240 (e.g., an outer microphone 242) is disposed may be formed on a side of the second case 220. According to an embodiment, the second case 220 may include a touch area configured to detect a touch of the user. The user may control an operation of the wearable device 101 by touching the touch area of the second case 220. For example, the wearable device 101 may include a touch sensor exposed to the outside in the touch area. The touch sensor may receive an external input for controlling an operation of the wearable device 101.

According to an embodiment, the first case 210 and the second case 220 may form the inner space 201 of the case 200 by being coupled to each other. For example, a coupling method of the first case 210 and the second case 220 may be a snap-fit method, a screw coupling method, a magnetic coupling method, or a force fitting method, but embodiments are not limited thereto.

A speaker 230 may receive an electrical signal and may output a sound or a signal based on the received electrical signal. According to an embodiment, the speaker 230 may be disposed adjacent to the first case 210 to transmit the output sound to the outside of the wearable device 101.

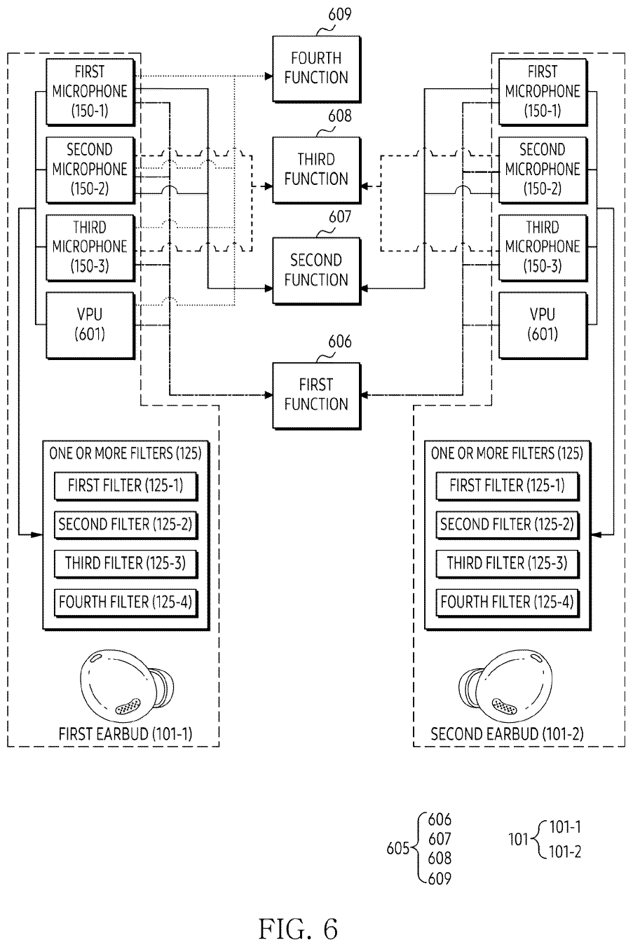

The microphone 240 may receive an audio signal and may generate an electrical signal based on the received audio signal. For example, the microphone 240 may be a feedback microphone for active noise cancellation (ANC) to cancel noise. According to an embodiment, the microphone 240 may include an inner microphone 241 disposed to direct the first case 210 and an outer microphone 242 disposed to direct the second case 220. However, an embodiment of the disclosure is not limited thereto. According to an embodiment, the microphone 240 may include the inner microphone 241 and the outer microphone 242 identified based on a direction in which a voice signal is obtained. For example, the inner microphone 241 may include at least one microphone for obtaining a signal including voice (hereinafter, a voice signal) from a first direction toward a body part in a state in which the wearable device 101 is worn on the body part (e.g., the ear) of the user. For example, the outer microphone 242 may include at least one microphone for obtaining a voice signal from a second direction different from the first direction in a state in which the wearable device 101 is worn on the body part (e.g., the ear) of the user. For example, the at least one microphone included in the outer microphone 242 may include a main mic (e.g., a first microphone 150-1 of FIG. 6) and a sub mic (e.g., a second microphone 150-2 of FIG. 6) for obtaining the voice signal from the second direction. For example, the main mic may be used to obtain the voice signal from the second direction. For example, the sub mic may be used in a case in which the main mic is not used or a quality of a voice signal obtained from the main mic is less than or equal to a specified quality, or may be used to obtain the voice signal auxiliary with respect to the main mic. For example, the microphone 240 may be an electronic condenser microphone (ECM) or a micro electro mechanical system (MEMS), but embodiments are not limited thereto. In FIGS. 2A and 2B, three microphones 240 (e.g., two outer microphones 242 and one inner microphone 241) are exemplified, but an embodiment of the disclosure is not limited thereto. For example, the wearable device 101 may include the larger number of outer microphones or inner microphones than the number of microphones exemplified in FIGS. 2A and 2B. Alternatively, the wearable device 101 may include the smaller number of outer microphones or inner microphones than the number of microphones exemplified in FIGS. 2A and 2B.

According to an embodiment, an electronic component 250 may include a battery 251, a first circuit board 252, the terminal 253, the wearing detection sensor 254, a second circuit board 255, a connecting unit 256, and/or an acceleration sensor 257.

According to an embodiment, the battery 251 may supply power to at least one component of the wearable device 101. For example, the battery 251 may include a non-rechargeable primary battery, a rechargeable secondary battery, or a fuel cell.

According to an embodiment, the first circuit board 252 may be disposed adjacent to the first case 210. For example, the first circuit board 252 may be electrically connected to the speaker 230 and the inner microphone 241.

According to an embodiment, the terminal 253 electrically connecting the battery 251 to an external charging device may be disposed in the first circuit board 252. The terminal 253 may be disposed in the first circuit board 252 such that a portion of the terminal 253 passes through the terminal hole 211 formed in the first case 210 and is exposed to the outside of the wearable device 101. For example, the external charging device connected to the wearable device 101 through the terminal 253 may be a cradle for supplying power to the battery 251. The terminal 253 may be connected to a terminal of the external charging device such as the cradle, such as a charging device or a charging case of the wearable device. The terminal 253 may supply power to the wearable device 101 through the terminal of the external charging device. For example, the power supplied to the wearable device 101 may be used to charge the battery 251. The terminal hole 211 may be formed on a side surface of the wearable device 101 facing a seating surface of the external device when the wearable device 101 is seated on the external charging device. For example, when the wearable device 101 is seated on the charging case of the wearable device 101 in a specified state, the terminal hole 211 may be formed at a position corresponding to a charging terminal among surfaces in which the wearable device 101 contacts the charging case.

According to an embodiment, the wearing detection sensor 254 configured to detect whether the user wears the wearable device 101 may be disposed in the first circuit board 252. The wearing detection sensor 254 may be disposed in the first circuit board 252 such that a portion of the wearing detection sensor 254 passes through the sensor hole 212 formed in the first case 210 and is exposed to the outside of the wearable device 101. The wearing detection sensor 254 may detect a contact or an approach of a body part of the user. For example, the wearing detection sensor 254 may detect a case that the wearable device 101 is inserted into the external auditory canal of the user. The wearing detection sensor 254 may mean, for example, a proximity sensor, but embodiments are not limited thereto. The wearing detection sensor 254 may include an ultrasonic sensor, an infrared sensor, a touch sensor, or a combination thereof.

According to an embodiment, the second circuit board 255 may be disposed to be spaced apart from the first circuit board 252 and adjacent to the second case 220. For example, the second circuit board 255 may be disposed on another side of the battery 251 facing a side of the battery 251 disposed on the first circuit board 252. According to an embodiment, the second circuit board 255 may be electrically connected to the outer microphone 242. For example, the outer microphone 242 may be disposed in an area of the second circuit board 255 to correspond to a position of the microphone hole 221 of the second case 220. For example, the first circuit board 252 and the second circuit board 255 may be at least one of a printed circuit board (PCB) and a flexible printed circuit board (FPCB).

According to an embodiment, the connecting unit 256 may electrically connect the first circuit board 252 and the second circuit board 255. According to an embodiment, the connecting unit 256 may surround a portion of a sidewall of the battery 251, and may extend from the first circuit board 252 to the second circuit board 255. The connecting unit 256 may be, for example, at least one of a flexible printed circuit board (FPCB) formed of a polyimide material and a metal wire.

According to an embodiment, the acceleration sensor 257 may be disposed on the second circuit board 255. For example, the acceleration sensor 257 may indicate a sensor for measuring vibration or acceleration in relation to the wearable device 101. For example, the acceleration sensor 257 may measure information on vibration obtained from the body part (e.g., the ear) of the user. The vibration may be generated as the user utters voice. For example, the acceleration sensor 257 may generate an electrical signal based on the measured acceleration. For example, the acceleration sensor 257 may include a shear, flexural, or compression type. For example, the acceleration sensor 257 may include a vibration sensor, an accelerometer, a vibration accelerometer, or a voice pickup unit (VPU).

When the wearable device 101 is worn by the user, the ear tip 260 may adhere to an inner wall of the external auditory canal such that audio output from the speaker 230 is smoothly transmitted to the user. In an embodiment, the ear tip 260 may be formed of a silicon material. For example, at least one area of the ear tip 260 may be deformed according to a shape of the ear of the user when the wearable device 101 is worn by the user. For example, the ear tip 260 may be formed by a combination of at least one or more of silicon, foam, and plastic material.

The wearable device 101 according to an embodiment may improve a voice portion (e.g., a bandwidth corresponding to voice) of a voice signal obtained from the outside through at least one filter (e.g., the first filter 125-1 of FIG. 1). For example, the wearable device 101 may improve the voice portion through a speech enhancement technique.

In an example of the speech enhancement technique, the wearable device 101 may use a signal obtained from an accelerometer (hereinafter, an acceleration signal) and a signal obtained from a microphone (hereinafter, a microphone signal). For example, the wearable device 101 may obtain a signal with the enhanced voice portion by receiving the microphone signal at a time point identified by the acceleration signal.

As described above, the wearable device 101 according to embodiments of the disclosure may obtain (or identify) the signal (or voice data) with the enhanced voice portion by using a layer (e.g., one or more filters 125) with the microphone signal as an input. For example, the wearable device 101 according to embodiments of the disclosure may improve a voice quality of the user by using not only a voice signal obtained through a microphone but also a voice signal obtained through a sensor (e.g., a VPU 601 of FIG. 6). The wearable device 101 according to embodiments of the disclosure may more clearly distinguish a voice portion and a non-voice portion (e.g., a noise or interference portion) of the voice signal. In addition, the wearable device 101 according to embodiments of the disclosure may obtain a clearer voice by emphasizing a specific band (e.g., a low frequency band) of the voice signal. Hereinafter, an example of an operation in which the external electronic device 103 according to an embodiment identifies a wearing state of the wearable device 101 will be described with reference to FIG. 3.

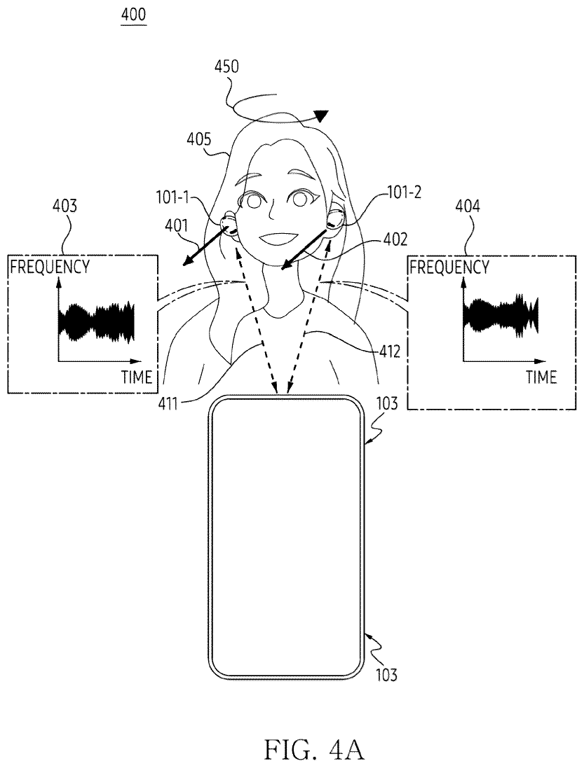

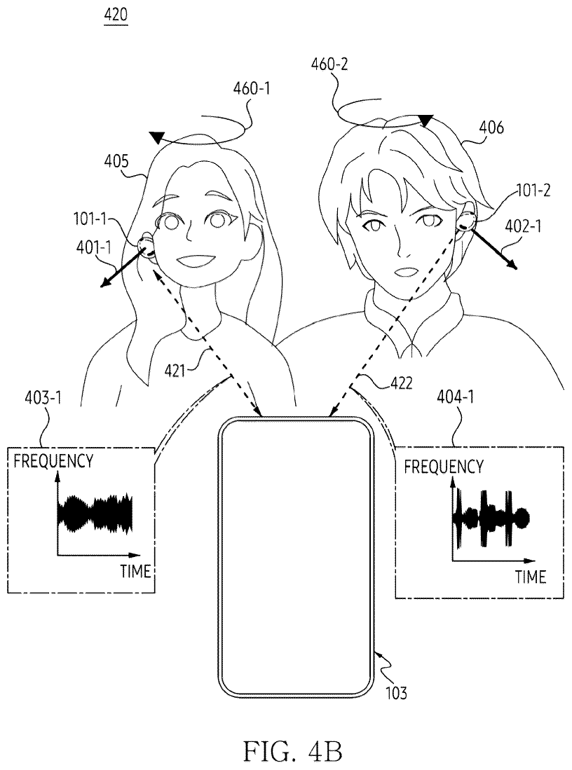

FIG. 3 illustrates an example of a flowchart indicating an operation of an electronic device according to an embodiment. FIGS. 4A and 4B illustrate an example of a wearing state of a wearable device according to an embodiment. An electronic device 103 of FIGS. 3 to 4B may include the external electronic device 103 of FIG. 1. At least one of the operations of FIG. 3 may be performed by the external electronic device 103 of FIG. 1 and/or the processor 110-1 of FIG. 1. Each of the operations of FIG. 3 may be performed sequentially, but the operations are not performed sequentially. For example, an order of each of the operations may be changed, and at least two operations may be performed in parallel. FIGS. 3, 4A, and 4B illustrate a recording mode automatic switching function in which voice of a single user or each of a plurality of users wearing wearable devices 101-1 and 101-2 on the users'ears is obtained by using a camera application or a voice recording application of the external electronic device 103 and stored in the external electronic device 103.

Referring to FIG. 3, in operation 310 according to an embodiment, an electronic device may transmit a first data signal for performing recording to a wearable device connected through communication circuit. The wearable device (e.g., the wearable device 101 of FIG. 1) may be referred to as a plurality of wearable devices in terms of including earbuds forming a pair. The electronic device may transmit the first data signal based on execution of a recording software application (e.g., the recording software application 121 of FIG. 1). The first data signal may include information requesting the plurality of wearable devices to obtain voice data. The first data signal may include a control signal for controlling at least one function that is performed by the wearable device.

Referring to FIG. 3, in operation 320 according to an embodiment, the electronic device may receive a first vector (e.g., 401 of FIG. 4A) indicating a posture of a first earbud (e.g., the first earbud 101-1 of FIG. 1) and a second vector (e.g., 402 of FIG. 4A) indicating a posture of a second earbud (e.g., the second earbud 101-2 of FIG. 1) from the wearable device. The first vector (e.g., 401 of FIG. 4A) and the second vector (e.g., 402 of FIG. 4A) may be identified through the sensor 130 included in the wearable device 101 of FIG. 1. An earbud may be referred to as a wearable device in terms of being worn by a user.

Referring to FIG. 3, in operation 330 according to an embodiment, the electronic device may receive first audio data of the first earbud and second audio data of the second earbud. The electronic device may receive the first audio data and the second audio data from the first earbud and the second earbud, respectively, based on a communication link (e.g., LE Audio).

Referring to FIG. 3, in operation 340, the electronic device according to an embodiment may check whether a vector difference between the first vector (e.g., 401 of FIG. 4A) and the second vector (e.g., 402 of FIG. 4A) exceeding a first threshold range is identified.

Referring to FIG. 4A, a state 400 may indicate a state in which the first earbud 101-1 and the second earbud 101-2 are worn by the same user 405. The external electronic device 103 according to an embodiment may transmit a data signal requesting the first earbud 101-1 and the second earbud 101-2 to perform recording based on execution of the recording software application 121.

The first earbud 101-1 and the second earbud 101-2 according to an embodiment may identify (or detect) a posture using sensing data obtained through a sensor (e.g., the acceleration sensor 257 of FIG. 2B). For example, the first earbud 101-1 may identify (or detect) a first vector 401 indicating the posture of the first earbud 101-1 through a sensor included in the first earbud 101-1. The first vector 401 may include a direction of acceleration and/or a magnitude of acceleration. For example, the second earbud 101-2 may identify (or detect) a second vector 402 indicating the posture of the second earbud 101-2 through a sensor included in the second earbud 101-2. The second vector 402 may include a direction of acceleration (or force) and/or magnitude of acceleration applied to the second earbud 101-2. For example, the first vector 401 and the second vector 402 may be identified based on a trajectory 450 indicating movement of the user 405 in the state 400 in which the first earbud 101-1 and the second earbud 101-2 are worn by the same user 405.

For example, the first earbud 101-1 may transmit a data signal indicating the first vector 401 to the external electronic device 103. The second earbud 101-2 may transmit a data signal indicating the second vector 402 to the external electronic device 103.

For example, the external electronic device 103 may identify (or detect) a difference between the first vector 401 and the second vector 402. For example, a vector difference between the first vector 401 and the second vector 402 in the state 400 may be included within the first threshold range. For example, in the state 400 in which the wearable device 101 is worn by the same user 405, the vector change value between the first vector 401 and the second vector 402 may be less than a specified threshold value. The external electronic device 103 may determine whether to identify (or detect) a phase difference of audio data based on identifying the vector difference included within the first threshold range.

Referring to FIG. 3, in a case that the vector difference between the first vector 401 and the second vector 402 included within the first threshold range is identified (e.g., the operation 340—NO), in operation 370, the electronic device according to an embodiment may identify (or detect) the state 400 of the wearable device worn by the same user.

Referring to FIG. 4B, a state 420 may include a state in which the first earbud 101-1 and the second earbud 101-2 are worn by different users 405 and 406. In the state 420, the wearable device 101 may receive a data signal for performing recording from the external electronic device 103. In the state 420, while being worn by the first user 405, the first earbud 101-1 may obtain a first vector 401-1 indicating the posture of the first earbud 101-1. While being worn by the second user 406, the second earbud 101-2 may obtain a second vector 402-2 indicating the posture of the second earbud 101-2. For example, the first earbud 101-1 may obtain the first vector 401-1 based on a trajectory 460-1 indicating movement of the first user 405, and the second earbud 101-2 may obtain the second vector 402-1 based on a trajectory 460-2 indicating movement of the second user 406. For example, the first earbud 101-1 and the second earbud 101-2 may transmit a data signal indicating the first vector 401-1 and the second vector 402-1 to the external electronic device 103.

For example, the external electronic device 103 may identify (or detect) a vector difference between the first vector 401-1 and the second vector 402-1. The external electronic device 103 may identify (or detect) the vector difference exceeding a first threshold range. The external electronic device 103 may identify (or detect) the wearing state 420 of the wearable device 101 worn by different users, based on identifying the vector difference exceeding the first threshold range. The external electronic device 103 according to an embodiment may identify (or detect) a phase difference between first audio data and second audio data based on identifying the vector difference exceeding the first threshold range.

Referring to FIG. 3, in a case where the vector difference between the first vector 401 or 401-1 and the second vector 402 or 402-2 is identified as exceeding the first threshold range (e.g., the operation 340—YES), in operation 350, the electronic device according to an embodiment may check whether the phase difference between the first audio data and the second audio data is identified as exceeding a second threshold range. As an example, the electronic device may perform the operation 340 and the operation 350 in parallel.

Referring to FIG. 4A, the first earbud 101-1 and the second earbud 101-2 according to an embodiment may receive an audio signal from the outside through at least one of a plurality of microphones (e.g., the plurality of microphones 150 of FIG. 1). For example, the first earbud 101-1 may obtain first audio data 403. The second earbud 101-2 may obtain second audio data 404. The first earbud 101-1 may transmit a data signal 411 indicating the first audio data 403 to the external electronic device 103. The second earbud 101-2 may transmit a data signal 412 indicating the second audio data 404 to the external electronic device 103. According to an embodiment, the data signal 411 may include the data signal indicating the first vector 401. The data signal 412 may include the data signal indicating the second vector 402.

For example, the external electronic device 103 may identify (or detect) a phase corresponding to each of the first audio data 403 and the second audio data 404. The external electronic device 103 may identify (or detect) a difference between a first phase corresponding to the first audio data 403 and a second phase corresponding to the second audio data 404. For example, the external electronic device 103 may identify (or detect) the difference of the phases by comparing a data value included in the first audio data 403 and a data value included in the second audio data 404 at the same time point. However, embodiments are not limited thereto.

For example, in the state 400 of being worn by the same user 405, the first audio data 403 and the second audio data 404 may include substantially similar information (e.g., correlation information). The external electronic device 103 may identify (or detect) the wearing state 400 of the wearable device 101 worn by the same user 405, based on identifying the phase difference between the first audio data 403 and the second audio data 404 included within the second threshold range. The second threshold range may be set to include a phase difference according to a distance between both ears of the user 405, and/or a phase difference based on frequency distortion generated by reflection on a body part.

Referring to FIG. 3, in a case of identifying the phase difference between the first audio data 403 and the second audio data 404 included within the second threshold range (e.g., the operation 350—NO), in the operation 370, the electronic device according to an embodiment may identify (or detect) a state of the wearable device worn by the same user. The electronic device may transmit a data signal indicating the wearing state of the wearable device to the wearable device. The wearable device may select at least one of the plurality of microphones to perform recording based on identifying the wearing state. The wearable device may obtain voice data based on at least one filter, using a voice signal received through the at least one microphone selected to perform recording. An operation in which the wearable device obtains the voice data will be described later with reference to FIG. 5.

Referring to FIG. 4B, the first earbud 101-1 according to an embodiment may obtain first audio data 403-1 through at least one of the plurality of microphones. The second earbud 101-2 may obtain second audio data 404-1 through at least one of the plurality of microphones. A portion of information included in the first audio data 403-1 may include a portion indicating a voice of the first user 405. A portion of information included in the second audio data 404-1 may include a portion indicating a voice of the second user 406. An amplitude corresponding to the first audio data 403-1 may be different from an amplitude corresponding to the second audio data 404-1. For example, a frequency corresponding to the first audio data 403-1 may be different from a frequency corresponding to the second audio data 404-1. The first earbud 101-1 may transmit a data signal 421 indicating the first audio data 403-1 to the external electronic device 103. The second earbud 101-2 may transmit a data signal 422 indicating the second audio data 404-1 to the external electronic device 103.

For example, the external electronic device 103 may identify (or detect) a phase difference between the first audio data 403-1 and the second audio data 404-1 exceeding a specified threshold range. The external electronic device 103 may identify (or detect) the wearing state of the wearable device 101 according to whether a difference between at least one value of the first audio data 403-1 and at least one value of the second audio data 404-1 exceeds the specified threshold range.

Referring to FIG. 3, in a case of identifying the phase difference between the first audio data 403 or 403-1 and the second audio data 404 or 404-1 exceeding the second threshold range (e.g., the operation 350—YES), in operation 360, the electronic device according to an embodiment may identify (or detect) the state of the wearable device worn by different users. The electronic device may identify (or detect) the wearing state of the wearable device using the vector difference and the phase difference. The electronic device may transmit information indicating the wearing state to the wearable device.

As described above, the external electronic device 103 according to an embodiment may identify (or detect) the wearing state of the wearable device 101, using information indicating a posture of the wearable device 101 received from the wearable device 101 and audio data received from the wearable device 101, while performing a recording function. For example, by using the posture of the wearable device 101 and a phase difference of an audio signal, the external electronic device 103 may identify (or detect) the wearing state of the wearable device 101 more accurately than identifying the wearing state using the posture of the wearable device 101.

The external electronic device 103 may transmit information indicating the wearing state of the wearable device 101 to the wearable device 101. Based on the wearable device 101 receiving the information on the wearing state, the wearable device 101 may determine a filter and/or a microphone for a function for recording (e.g., mono recording or binaural recording). Hereinafter, an example of an operation in which the wearable device 101 according to an embodiment determines the microphone or the filter according to the wearing state will be described later with reference to FIG. 5.

FIG. 5 illustrates an example of a flowchart indicating an operation of a wearable device according to an embodiment. FIG. 6 illustrates an example of functions performed according to a wearing state of a wearable device according to an embodiment. A wearable device 101 of FIGS. 5 and 6 may include the wearable device 101 of FIG. 1. At least one of the operations of FIG. 5 may be performed by the wearable device 101 of FIG. 1 and/or the processor 110 of FIG. 1. Each of the operations of FIG. 5 may be performed sequentially, but is not necessarily performed sequentially. For example, an order of each of the operations may be changed, and at least two operations may be performed in parallel.

Referring to FIG. 5, a wearable device according to an embodiment may receive a first data signal for identifying at least one filter among a plurality of filters applicable to audio data output from a plurality of microphones from an external electronic device. For example, the external electronic device (e.g., the external electronic device 103 of FIG. 1) may transmit the first data signal to the wearable device 101 based on execution of a recording software application. The first data signal may include a request to obtain a voice signal through a microphone of the wearable device 101. The first data signal may include information on a wearing state (e.g., the state 400 of FIG. 4A or the state 420 of FIG. 4B) of the wearable device. The first data signal may include information for indicating at least one filter among one or more filters. The first data signal may include information for selecting at least one microphone among the plurality of microphones. For example, the one or more filters may include a filter for mono recording in a state in which a first earbud (e.g., the first earbud 101-1 of FIG. 1) and a second earbud (e.g., the second earbud 101-2 of FIG. 1) paired with the first earbud are worn by different users.

For example, the wearable device 101 may transmit information indicating a posture of the wearable device 101 to the external electronic device 103 based on receiving the first data signal. The wearable device 101 may transmit information indicating a posture of the first earbud and a posture of the second earbud paired with the first earbud to the external electronic device.

For example, the wearable device 101 may transmit audio data received through at least one microphone among the plurality of microphones to the external electronic device.

For example, the external electronic device 103 may identify (or detect) whether the wearable device 101 is in a state worn by a plurality of users (e.g., the state 420 of FIG. 4B) or in a state worn by the same user (e.g., the state 400 of FIG. 4A), based on the information indicating the posture of the wearable device 101 and the audio data. The external electronic device 103 may transmit a data signal indicating the wearing state of the wearable device 101 to the wearable device 101. The wearable device 101 according to an embodiment may identify (or detect) a change from a state worn by the different users (e.g., the state 420 of FIG. 4B) to a state worn by a single user (e.g., the state 400 of FIG. 4A). The external electronic device may identify (or detect) a transition from the state 420 of FIG. 4B to the state 400 of FIG. 4A of the wearable device 101 by identifying the posture of the first earbud and the posture of the second earbud. While performing mono recording, the wearable device 101 may cease the mono recording and perform binaural recording based on transmitting a data signal indicating the transition.

Referring to FIG. 5, in operation 520, according to an embodiment, the wearable device 101 may identify (or detect) at least one microphone for mono recording among the plurality of microphones based on receiving the first data signal. The wearable device 101 may determine whether to use an acceleration sensor based on receiving the first data signal. For example, the wearable device 101 may initiate execution of at least one function based on receiving the first data signal. The wearable device 101 may identify (or detect) the wearing state of the wearable device 101 based on receiving the first data signal. After receiving the first data signal requesting to perform recording, the wearable device 101 may determine whether to perform the mono recording or perform the binaural recording, based on identifying the wearing state.

The external electronic device 103 according to an embodiment may control an operation of the wearable device 101 based on identifying the wearing state of the wearable device 101. For example, based on identifying the state 400 of FIG. 4A, the external electronic device 103 may transmit a first control signal requesting the wearable device 101 to obtain a voice signal based on the binaural recording. Based on identifying the state 420 of FIG. 4B, the external electronic device 103 may transmit a second control signal requesting the wearable device 101 to obtain a voice signal based on the mono recording. The wearable device 101 may perform recording corresponding to the received first control signal or second control signal based on receiving the first control signal or the second control signal. However, embodiments are not limited thereto.

Referring to FIG. 5, in operation 530, according to an embodiment, the wearable device 101 may obtain voice data by applying the filter for the mono recording among the plurality of filters to a voice signal received through at least one microphone. For example, the wearable device 101 may obtain voice data by applying the filter for the mono recording to the voice signal received from at least one of the plurality of microphones. For example, the voice data may include information in which a voice portion included in the voice signal is enhanced. The voice data may include information in which a noise portion included in the voice signal is suppressed.

Referring to FIG. 6, the wearable device 101 according to an embodiment may identify (or detect) a hardware and/or software configuration for performing one or more functions 605. For example, the wearable device 101 may map the hardware configuration and/or the software configuration to each of the one or more functions 605.

For example, the wearable device 101 may receive a signal (e.g., a data signal) indicating performance of a first function 606 from an external electronic device (e.g., the external electronic device 103 of FIG. 1). The first function 606 may include a function related to mono recording. Based on receiving a signal indicating initiation of the first function 606, the wearable device 101 may identify (or detect) a first microphone 150-1, a second microphone 150-2, and a VPU 601. Based on performing the first function 606, the wearable device 101 may obtain a voice signal (or an audio signal) from the outside of the wearable device 101 using the first microphone 150-1, the second microphone 150-2, and the VPU 601. The first microphone 150-1 may be included in the outer microphone 242 of FIG. 2B. The second microphone 150-2 may be included in the outer microphone 242 of FIG. 2B. According to an embodiment, the first microphone 150-1 may be referred to as a main mic and the second microphone 150-2 may be referred to as a sub mic. A third microphone 150-3 may be included in the inner microphone 241 of FIG. 2B.

For example, the voice pickup unit (VPU) 601 may be included in an acceleration sensor (e.g., the acceleration sensor 257 of FIG. 2B) in terms of using acceleration. The wearable device 101 may obtain a voice signal based on identifying a specified vibration through the VPU 601 (e.g., a bone vibration sensor). For example, an operation in which the wearable device 101 obtains the voice signal using the VPU 601 may be referred to as a beamforming operation.

For example, the wearable device 101 may obtain voice data by applying a first filter 125-1 mapped to the first function 606 to the obtained voice signal. The wearable device 101 may transmit a signal indicating the voice data to the external electronic device 103. The external electronic device 103 may record the voice data included in the signal.

The wearable device 101 according to an embodiment may receive a data signal to initiate execution of a second function 607 from the external electronic device 103. For example, the second function 607 may include a function related to binaural recording. Based on initiating the execution of the second function 607, the wearable device 101 may receive an audio signal (or a voice signal) from the outside through the first microphone 150-1 and the second microphone 150-2. The wearable device 101 may process the audio signal using a second filter 125-2 mapped to the second function 607. The second filter 125-2 may be referred to as a stereoscopic sound filter.

The wearable device 101 according to an embodiment may receive an audio signal through the second microphone 150-2 and the third microphone 150-3 based on receiving a data signal indicating initiation of execution of a third function 608. The third function 608 may be referred to as an ANC function. Based on receiving the audio signal, the wearable device 101 may generate a tuning signal to suppress a portion related to noise included in the audio signal. The wearable device 101 may generate the tuning signal using a third filter 125-3 mapped to the third function 608. For example, the wearable device 101 may generate a tuning signal having a phase opposite to a noise signal indicating the portion related to the noise, by using the third filter 125-3. The wearable device 101 may obtain audio data in which the portion related to the noise is suppressed, by using the audio signal and the tuning signal.

The wearable device 101 according to an embodiment may receive a data signal for performing a fourth function 609 from the external electronic device 103. The fourth function 609 may include a function related to a call. Based on execution of the fourth function 609, the wearable device 101 may obtain a voice signal using a plurality of microphones and/or the VPU 601 included in one of the first earbud 101-1 and the second earbud 101-2. For example, the wearable device may obtain a voice signal using one of the first earbud 101-1 and the second earbud 101-2 to execute the fourth function 609. The wearable device 101 may change the voice signal into voice data using a fourth filter 125-4 mapped to the fourth function 609. The voice data may be obtained based on enhancing a voice portion included in the voice signal or suppressing a noise portion included in the voice signal. However, embodiments are not limited thereto.

The wearable device 101 according to an embodiment may perform not only the first function 606 to the fourth function 609, but also an ambient sound allowance function or a personal sound amplification products (PSAP) function for listening to an ambient sound using a plurality of microphones (e.g., the plurality of microphones 150 of FIG. 1). In order to amplify a noise sound received from the plurality of microphones, the wearable device 101 may generate a tuning signal corresponding to the noise signal. The tuning signal may be generated based on second phase information for amplifying first phase information of the noise signal. For example, the ambient sound allowance function and the PSAP function may be distinguished according to a degree to which the noise signal is amplified by the tuning signal. The ambient sound allowance function may include, for example, an ambient sound listening function, an ambient function, or a transparency function.

The wearable device 101 according to an embodiment may initiate execution of the second function 607 based on receiving a data signal for performing recording from the external electronic device 103. The wearable device 101 may transmit audio data corresponding to an audio signal obtained through the first microphone 150-1 and the second microphone 150-2 to the external electronic device 103 based on the second function 607.

For example, the external electronic device 103 may identify (or detect) a posture of the wearable device 101 using the audio signal. In a case that a state of the wearable device 101 is a first state (e.g., the state 400 of FIG. 4A), the external electronic device 103 may transmit a data signal for maintaining execution of the second function 607 to the wearable device 101. For example, in a case that a state of the wearable device 101 is a second state (e.g., the state 420 of FIG. 4B), the external electronic device 103 may transmit a data signal requesting the wearable device 101 to obtain an audio signal based on the first function 606. The wearable device 101 may determine whether to perform the mono recording corresponding to the first function 606 or the binaural recording corresponding to the second function 607 according to a wearing state of the wearable device 101 received from the external electronic device 103. The wearable device 101 may transmit a data signal indicating an audio signal (or a voice signal) received based on execution of the first function 606 or the second function 607 to the external electronic device 103.

Referring to FIG. 5, in operation 540, according to an embodiment, the wearable device may transmit a second data signal indicating voice data to the external electronic device. The external electronic device 103 may record a voice signal corresponding to the voice data based on receiving the second data signal. The external electronic device 103 may record the voice signal based on execution of the recording software application.

As described above, the wearable device 101 according to an embodiment may determine whether to perform the mono recording or perform the binaural recording according to the wearing state of the wearable device 101. For example, in a state in which the wearable device 101 is worn by different users, a clearer voice signal of each user may be obtained when the mono recording is performed other than a voice signal of each user obtained based on the binaural recording.

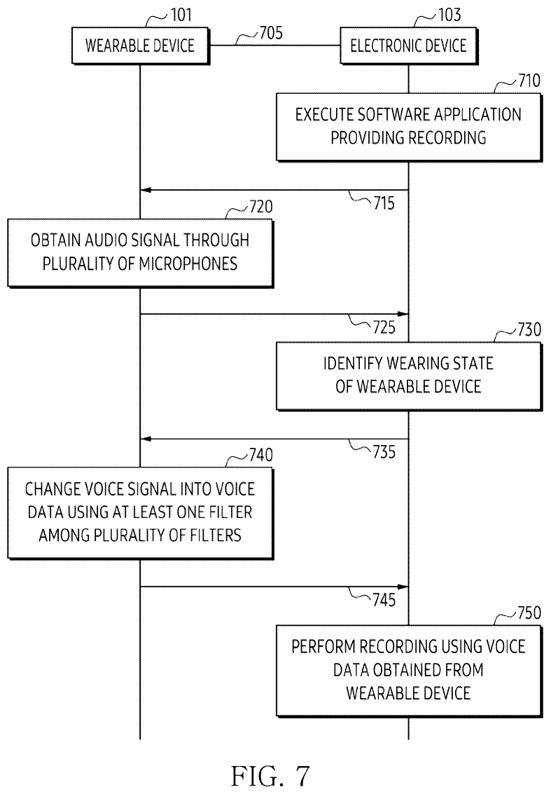

FIG. 7 illustrates an example of a signal flow diagram between a wearable device and an electronic device according to an embodiment. Referring to FIG. 7, a wearable device 101 may be referred to as the wearable device 101 of FIG. 1. An external electronic device 103 may be referred to as the external electronic device 103 of FIG. 1. Referring to FIG. 7, the wearable device 101 and the external electronic device 103 may establish a communication link (e.g., LE Audio) 705.

In operation 710, the external electronic device 103 according to an embodiment may receive an input indicating execution of a software application providing recording. In response to receiving the input, the external electronic device 103 may initiate execution of the software application. The external electronic device 103 may transmit, to the wearable device 101, a data signal 715 requesting obtaining of a voice signal for performing recording.

In operation 720, the wearable device 101 according to an embodiment may obtain an audio signal through a plurality of microphones based on receiving the data signal 715. The wearable device 101 may transmit a data signal 725 indicating the audio signal to the external electronic device 103. The wearable device 101 may change the audio signal into audio data through at least one of one or more filters. The data signal 725 may include vector information indicating a posture of the wearable device 101.

In operation 730, the external electronic device 103 according to an embodiment may identify (or detect) a wearing state of the wearable device. The external electronic device 103 may identify (or detect) the wearing state of the wearable device 101 using the vector information and the audio signal. The external electronic device 103 may identify (or detect) the wearing state based on a difference between a first vector value indicating a posture of a first earbud (e.g., the first earbud 101-1 of FIG. 1) and a second vector value of a second earbud (e.g., the second earbud 101-2 of FIG. 1). The external electronic device 103 may identify (or detect) the wearing state based on a difference between a phase of first audio data 403-1 received from the first earbud and a phase of second audio data 404 or 404-1 received from the second earbud. The wearing state of the wearable device 101 may include a first state (e.g., the state 400 of FIG. 4A) in which the first earbud and the second earbud are worn by the same user and a second state (e.g., the state 420 of FIG. 4B) in which the first earbud and the second earbud are worn by different users. The external electronic device 103 may transmit a data signal 735 indicating the wearing state of the wearable device to the wearable device 101.

In operation 740, the wearable device 101 according to an embodiment may change a voice signal into voice data by using at least one filter among a plurality of filters. For example, the wearable device 101 may initiate performance of mono recording in the second state. The wearable device 101 may identify (or detect) a filter for the mono recording. The wearable device 101 may identify (or detect) at least one microphone and VPU for performing the mono recording. The wearable device 101 may identify (or detect) vibration generated when a user speaks through the VPU. The wearable device 101 may obtain the voice signal through at least one microphone while identifying the vibration. As an example, the wearable device 101 may obtain the voice signal corresponding to the vibration. For example, the wearable device 101 may obtain voice signals from each of the first earbud and the second earbud for performing the mono recording. As an example, the voice signals may include information indicating a voice of each of the different users.

For example, the wearable device 101 may enhance a bandwidth indicating the voice of each of the users included in the voice signals, by using the filter for the mono recording. The wearable device 101 may obtain voice data indicating the voice signal having the enhanced bandwidth. The wearable device 101 may transmit a data signal 745 indicating the voice data to the external electronic device 103.

In operation 750, the external electronic device 103 according to an embodiment may perform recording using the voice data obtained from the wearable device. The wearable device 101 may obtain an audio file including the voice data or a video file including the voice data. However, embodiments are not limited thereto.

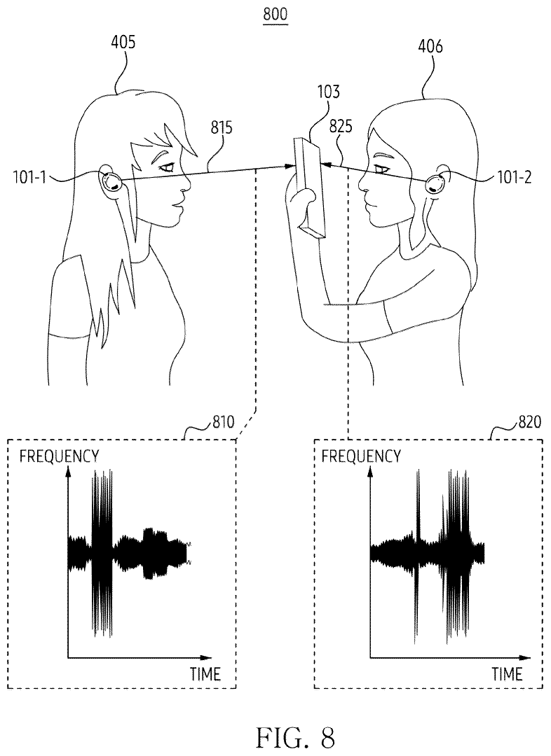

FIG. 8 illustrates an example of an operation in which a wearable device according to an embodiment obtains a voice signal from each of different users. A wearable device 101 of FIG. 8 may be referred to as the wearable device 101 of FIG. 1. A state 800 of FIG. 8 may be included in the state 420 of FIG. 4B.

The wearable device 101 according to an embodiment may be worn by different users 405 and 406 in the state 800. For example, a first earbud 101-1 may be worn on a right auricle of the first user 405. A second earbud 101-2 may be worn on a left auricle of the second user 406. The wearable device 101 may receive a data signal indicating initiation of recording from an external electronic device 103. The wearable device 101 may obtain an audio signal using at least one of a plurality of microphones based on receiving the data signal. For example, the data signal may include information on the state 800. The wearable device 101 may identify (or detect) at least one microphone among the plurality of microphones based on a wearing state of the wearable device 101. The wearable device 101 may obtain a voice signal through the at least one microphone by using an acceleration sensor based on the wearing state of the wearable device 101.

For example, the first earbud 101-1 may identify (or detect) vibration occurring while the first user 405 utters through a VPU (e.g., the VPU 601 of FIG. 6). While identifying the vibration, the first earbud 101-1 may obtain a voice signal indicating a voice of the first user 405 through at least one microphone (e.g., the first microphone 150-1 and/or the second microphone 150-2 of FIG. 6). Based on obtaining the voice signal, the first earbud 101-1 may change the voice signal into voice data 810 for transmitting to the external electronic device 103 through a filter (e.g., the first filter 250-1 of FIG. 1) for mono recording. For example, the first earbud 101-1 may obtain the voice data 810 by emphasizing a voice bandwidth corresponding to the voice of the first user 405 included in the voice signal. The first earbud 101-1 may obtain the voice data 810 by suppressing a noise bandwidth indicating noise distinct from the voice bandwidth. The first earbud 101-1 may transmit a data signal 815 indicating the voice data 810 to the external electronic device 103. The external electronic device 103 may obtain the voice data 810 based on receiving the data signal 815.

For example, the second earbud 101-2 may identify (or detect) vibration occurring while the second user 406 utters through a VPU (e.g., the VPU 601 of FIG. 6) included in the second earbud 101-2. While identifying the vibration, the second earbud 101-2 may obtain a voice signal indicating the voice of the second user 406 through at least one microphone (e.g., the first microphone 150-1 and/or the second microphone 150-2 of FIG. 6). Based on obtaining the voice signal, the second earbud 101-2 may change the voice signal into voice data 820 for transmitting to the external electronic device 103 through the filter (e.g., the first filter 125-1 of FIG. 1) for the mono recording. For example, the second earbud 101-2 may obtain the voice data 820 by emphasizing a voice bandwidth corresponding to the voice of the second user 406 included in the voice signal. The second earbud 101-2 may obtain the voice data 820 by suppressing a noise bandwidth indicating noise distinct from the voice. The second earbud 101-2 may transmit a data signal 825 indicating the voice data 820 to the external electronic device 103. The external electronic device 103 may obtain the voice data 820 based on receiving the data signal 825.

The external electronic device 103 according to an embodiment may obtain the voice data 810 corresponding to the voice of the first user 405 and the voice data 820 corresponding to the voice of the second user 406 from the wearable device 101. The external electronic device 103 may obtain an audio file and/or a video file including the voice data 810 and the voice data 820. The voice data 810 and the voice data 820 may be data temporally synchronized through a communication link.

As described above, in a state of being worn by the different users, the wearable device 101 according to an embodiment may obtain voice data indicating the voice of each of the different users by performing the mono recording. The wearable device 101 may execute a function (e.g., the mono recording) corresponding to the wearing state based on identifying the wearing state of the wearable device 101. The wearable device 101 may obtain a clear voice of each of the different users by executing, independently of a user input for initiating the function, a function mapped according to the wearing state.

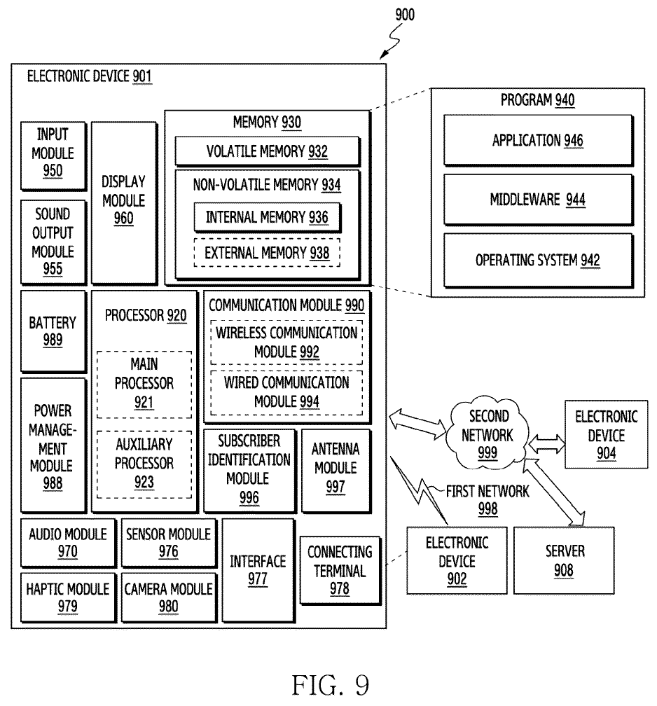

FIG. 9 is a block diagram illustrating an external electronic device 901 in a network environment 900 according to various embodiments. Referring to FIG. 9, the external electronic device 901 in the network environment 900 may communicate with another external electronic device 902 via a first network 998 (e.g., a short-range wireless communication network), or at least one of an electronic device 904 or a server 908 via a second network 999 (e.g., a long-range wireless communication network). According to an embodiment, the external electronic device 901 may communicate with the electronic device 904 via the server 908. According to an embodiment, the external electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module(SIM) 996, or an antenna module 997. In some embodiments, at least one of the components (e.g., the connecting terminal 978) may be omitted from the external electronic device 901, or one or more other components may be added in the external electronic device 901. In some embodiments, some of the components (e.g., the sensor module 976, the camera module 980, or the antenna module 997) may be implemented as a single component (e.g., the display module 960).

The processor 920 may execute, for example, software (e.g., a program 940) to control at least one other component (e.g., a hardware or software component) of the external electronic device 901 coupled with the processor 920, and may perform various data processing or computation. According to an embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the external electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the external electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the external electronic device 901 where the artificial intelligence is performed or via a separate server (e.g., the server 908). Learning algorithms may include, e.g., supervised learning, unsupervised learning, semi-supervised learning, or reinforcement learning. However, embodiments are not limited thereto. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but embodiments are not limited thereto. The artificial intelligence model may, additionally or alternatively, include a software structure other than the hardware structure.

The memory 930 may store various data used by at least one component (e.g., the processor 920 or the sensor module 976) of the external electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the external electronic device 901, from the outside (e.g., a user) of the external electronic device 901. The input module 950 may include, for example, a microphone, a mouse, a keyboard, a key (e.g., a button), or a digital pen (e.g., a stylus pen).

The sound output module 955 may output sound signals to the outside of the external electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the external electronic device 901. The display module 960 may include, for example, a display, a hologram device, or a projector and a control circuit to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., another external electronic device 902) directly (e.g., via a wired connection) or wirelessly coupled with the external electronic device 901.

The sensor module 976 may detect an operational state (e.g., power or temperature) of the external electronic device 901 or an environmental state (e.g., a state of a user) external to the external electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the external electronic device 901 to be coupled with the external electronic device (e.g., another external electronic device 902) directly (e.g., via a wired connection) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the external electronic device 901 may be physically connected with the external electronic device (e.g., another external electronic device 902). According to an embodiment, the connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the external electronic device 901. According to an embodiment, the power management module 988 may be implemented as at least part of, for example, a power management integrated circuit (PMIC).

The battery 989 may supply power to at least one component of the external electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the external electronic device 901 and the external electronic device (e.g., another external electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the external electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the mmWave band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the external electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 964 dB or less) for implementing mMTC, or U-plane latency (e.g., 0.5 ms or less for each of downlink (DL) and uplink (UL), or a round trip of 9 ms or less) for implementing URLLC.

The antenna module 997 may transmit or receive a signal or power to or from the outside (e.g., the external electronic device) of the external electronic device 901. According to an embodiment, the antenna module 997 may include an antenna including a radiating element composed of a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the external electronic device 901 and the external electronic device 904 via the server 908 coupled with the second network 999. Each of the external electronic devices 902 or 904 may be a device of a same type as, or a different type, from the external electronic device 901. According to an embodiment, all or some of the operations to be executed at the external electronic device 901 may be executed at one or more of the external electronic devices 902, 904, or 908. For example, in case that the external electronic device 901 should perform a function or a service automatically, or in response to a request from a user or another device, the external electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the external electronic device 901. The external electronic device 901 may provide the outcome, with or without further processing of the outcome, as at least part of a reply to the request. To that end, a cloud computing, distributed computing, mobile edge computing (MEC), or client-server computing technology may be used, for example. The external electronic device 901 may provide ultra low-latency services using, e.g., distributed computing or mobile edge computing. In another embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The external electronic device 901 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., via a wired connection), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuit”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the external electronic device 901). For example, a processor (e.g., the processor 920) of the machine (e.g., the external electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. The external electronic device 901 of FIG. 9 may be referred to as the external electronic device 103 of FIG. 1.

A wearable device 101 according to an embodiment may identify at least one microphone for recording among a plurality of microphones according to a wearing state of the wearable device. The wearable device 101 may obtain audio data for transmitting an audio signal obtained through at least one microphone to an electronic device 103 through a filter related to the wearing state. A method for the wearable device to select a microphone and/or a filter according to the wearing state may be required.

As described above, a first earbud 101-1 according to an embodiment may include a speaker 140, a communication circuit 160, a plurality of microphones 150, an acceleration sensor 257, at least one processor 110 including a processing circuit, and memory 120 including one or more storage media storing instructions. The instructions, when executed by the at least one processor, individually or collectively, may cause the first earbud to receive a first data signal 715 from an external electronic device 103 to identify at least one of a plurality of filters 125 applicable to audio data output from the plurality of microphones. The plurality of filters may include a filter 125-1 for mono recording in a state 420 in which the first earbud and a second earbud 101-2 paired with the first earbud are worn by different users 405 and 406. The instructions, when executed by the at least one processor, individually or collectively, may cause the first earbud to identify at least one microphone 150-1 and/or 150-2 for the mono recording among the plurality of microphones based on receiving the first data signal. The instructions, when executed by the at least one processor, individually or collectively, may cause the first earbud to obtain voice data 810 and 820 by applying the filter for the mono recording among the plurality of filters to a voice signal received through the at least one microphone. The instructions, when executed by the at least one processor, individually or collectively, may cause the first earbud to transmit a second data signal 745 indicating the voice data to the external electronic device 103.

For example, the instructions, when executed by the at least one processor, individually or collectively, may cause the first earbud to transmit a third data signal 725 indicating audio data output from the plurality of microphones to the external electronic device 103. The instructions, when executed by the at least one processor, individually or collectively, may cause the first earbud to identify the filter for the mono recording among the plurality of filters, in response to receiving the first data signal indicating the state identified based on a phase difference between the audio data and the other audio data of the second earbud, by the external electronic device 103.

For example, the instructions, when executed by the at least one processor, individually or collectively, may cause the first earbud to transmit a fourth data signal indicating a first vector 401 or 401-1 identified using the acceleration sensor to the external electronic device 103. The instructions, when executed by the at least one processor, individually or collectively, may cause the first earbud to identify the filter for the mono recording among the plurality of filters based on receiving the first data signal indicating the state identified based on a difference between the first vector 401 or 401-1 and a second vector 402 or 402-1 of the second earbud, exceeding a threshold range, by the external electronic device 103.

For example, the instructions, when executed by the at least one processor, individually or collectively, may cause the first earbud to receive the voice signal through the at least one microphone, while identifying a specified vibration using the acceleration sensor.

For example, the filter for the mono recording may be set to remove a frequency band indicating noise included in the voice signal.

As described above, an external electronic device 103 according to an embodiment may include a communication circuit 160-1, at least one processor 110-1 including a processing circuit, and memory 120-1 including one or more storage media storing instructions. The instructions, when executed by the at least one processor, individually or collectively, may cause the external electronic device 103 to transmit a first data signal 715 for performing recording to a plurality of wearable devices 101 forming a pair connected through the communication circuit. The instructions, when executed by the at least one processor, individually or collectively, may cause the external electronic device 103 to receive first audio data 403-1 of a first wearable device 101-1 among the plurality of wearable devices and second audio data 404 or 404-1 of a second wearable device 101-2 among the plurality of wearable devices, based on transmitting the first data signal. The instructions, when executed by the at least one processor, individually or collectively, may cause the external electronic device 103 to identify a phase difference between first audio data 403-1 received from the first wearable device 101-1 and second audio data 404 or 404-1 received from the second wearable device 101-2 exceeding a threshold range. The instructions, when executed by the at least one processor, individually or collectively, may cause the external electronic device 103 to identify a state 420 of the plurality of wearable devices worn by different users 405 and 406 based on identifying the phase difference exceeding the threshold range. The instructions, when executed by the at least one processor, individually or collectively, may cause the external electronic device 103 to transmit a third data signal 735 requesting to obtain voice data by applying a filter 125-1 for mono recording to the plurality of wearable devices, based on identifying the state.

For example, the instructions, when executed by the at least one processor, individually or collectively, may cause the external electronic device 103 to receive a first vector 401 or 401-1 indicating a posture of the first wearable device 101-1 from the first wearable device 101-1. The instructions, when executed by the at least one processor, individually or collectively, may cause the external electronic device 103 to receive a second vector 402 or 402-1 indicating a posture of the second wearable device 101-2 from the second wearable device 101-2. The instructions, when executed by the at least one processor, individually or collectively, may cause the external electronic device 103 to identify the state based on identifying a vector difference of the first vector 401 or 401-1 and the second vector 402 or 402-1 exceeding another threshold range.

For example, the instructions, when executed by the at least one processor, individually or collectively, may cause the external electronic device 103 to identify another state 400 of the plurality of wearable devices worn by the same user based on identifying the vector difference within the threshold range.

For example, the instructions, when executed by the at least one processor, individually or collectively, may cause the external electronic device 103 to transmit the first data signal to the plurality of wearable devices based on execution of a software application 121 providing the recording.

For example, the instructions, when executed by the at least one processor, individually or collectively, may cause the external electronic device 103 to obtain the voice data from the plurality of wearable devices based on transmitting the third data signal.

For example, the instructions, when executed by the at least one processor, individually or collectively, may cause the external electronic device 103 to transmit the third data signal requesting to obtain a voice signal using at least one microphone for the mono recording among a plurality of microphones 150 of the wearable devices.

For example, the voice signal may be obtained through the at least one microphone while a specified vibration is identified through an acceleration sensor 257 of the wearable devices.

For example, the instructions, when executed by the at least one processor, individually or collectively, may cause the external electronic device 103 to obtain the voice data changed from a voice signal indicating a voice of each of the different users from each of the plurality of wearable devices.

For example, the filter for the mono recording may be set to remove a frequency band indicating noise included in the voice signal.

As described above, a method of an external electronic device 103 according to an embodiment may include transmitting a first data signal 715 for performing recording to a plurality of wearable devices 101 forming a pair connected through a communication circuit 160-1. The method may include receiving first audio data 403-1 of a first wearable device 101-1 among the plurality of wearable devices and second audio data 404 or 404-1 of a second wearable device 102-2 among the plurality of wearable devices, based on transmitting the first data signal. The method may include identifying a phase difference between first audio data 403-1 received from the first wearable device 101-1 and second audio data 404 or 404-1 received from the second wearable device 101-2 exceeding a threshold range. The method may include identifying a state 420 of the plurality of wearable devices worn by different users 405 and 406 based on identifying the phase difference exceeding the threshold range. The method may include transmitting a third data signal 735 requesting to obtain voice data by applying a filter 125-1 for mono recording to the plurality of wearable devices, based on identifying the state.

For example, the identifying the state of the plurality of wearable devices may include receiving a first vector 401 or 401-1 indicating a posture of the first wearable device 101-1 from the first wearable device 101-1. The identifying the state of the plurality of wearable device may include receiving a second vector 402 or 402-1 indicating a posture of the second wearable device 101-2 from the second wearable device 101-2. The identifying the state of the plurality of wearable device may include identifying the state based on identifying a vector difference of the first vector 401 or 401-1 and the second vector 402 or 402-1 exceeding another threshold range.

For example, the identifying the state of the plurality of wearable device may include identifying another state 400 of the plurality of wearable devices worn by the same user based on identifying the vector difference within the threshold range.

For example, the transmitting the first data signal may include transmitting the first data signal to the plurality of wearable devices based on execution of a software application 121 providing the recording.

For example, the transmitting the third data signal may further include obtaining the voice data from the plurality of wearable devices based on transmitting the third data signal.

For example, the transmitting the third data signal may further include transmitting the third data signal requesting to obtain a voice signal using at least one microphone for the mono recording among a plurality of microphones 150 of the wearable devices.

As described above, a method of a first earbud may include receiving a first data signal 715 from a wearable device 101 to identify at least one of a plurality of filters 125 applicable to audio data output from a plurality of microphones. The plurality of filters may include a filter 125-1 for mono recording in a state 420 in which the first earbud and a second earbud 101-2 paired with the first earbud are worn by different users 405 and 406. The method may include identifying at least one microphone 150-1 and/or 150-2 for the mono recording among the plurality of microphones based on receiving the first data signal. The method may include obtaining voice data 810 and 820 by applying the filter for the mono recording among the plurality of filters to a voice signal received through the at least one microphone. The method may include transmitting a second data signal 745 indicating the voice data to the wearable device 101.

In a computer readable storage medium storing one or more programs, the one or more programs may be configured to, when executed by at least one processor of a first earbud, cause the first earbud to receive a first data signal from an external electronic device 103 to identify at least one of a plurality of filters applicable to audio data output from a plurality of microphones. The plurality of filters may include a filter for mono recording in a state in which the first earbud and a second earbud paired with the first earbud are worn by different users. The one or more programs may be configured to, when executed by the at least one processor, cause the first earbud to identify at least one microphone for the mono recording among the plurality of microphones based on receiving the first data signal. The one or more programs may be configured to, when executed by the at least one processor, cause the first earbud to obtain voice data by applying the filter for the mono recording among the plurality of filters to a voice signal received through the at least one microphone. The one or more programs may be configured to, when executed by the at least one processor, cause the first earbud to transmit a second data signal indicating the voice data to the external electronic device 103.

In a computer readable storage medium storing one or more programs, the one or more programs may be configured to, when executed by at least one processor of an external electronic device 103 including a communication circuit and the at least one processor, cause the external electronic device 103 to transmit a first data signal for performing recording to a plurality of wearable devices forming a pair connected through the communication circuit. The one or more programs may be configured to, when executed by the at least one processor, cause the external electronic device 103 to receive first audio data 403-1 of a first wearable device 101-1 among the plurality of wearable devices and second audio data 404 or 404-1 of a second wearable device 101-2 among the plurality of wearable devices, based on transmitting the first data signal. The one or more programs may be configured to, when executed by the at least one processor, cause the external electronic device 103 to identify a phase difference between first audio data 403 or 403-1 received from the first wearable device 101-1 and second audio data 404 or 404-1 received from the second wearable device 101-2 exceeding a threshold range. The one or more programs may be configured to, when executed by the at least one processor, identify a state of the plurality of wearable devices worn by different users based on identifying the phase difference exceeding the threshold range. The at least one processor may be configured to cause the external electronic device 103 to transmit a third data signal requesting to obtain voice data by applying a filter for mono recording to the plurality of wearable devices, based on identifying the state.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that is performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. A first earbud, comprising:
a speaker;
a communication circuit;
a plurality of microphones;
an acceleration sensor;
at least one processor comprising processing a circuit; and
memory comprising one or more storage media storing instructions,
wherein the instructions, based on being executed by the at least one processor, individually or collectively, cause the first earbud to:
receive a first data signal from an external electronic device to identify at least one of a plurality of filters for audio data output from the plurality of microphones, wherein the plurality of filters comprises a filter for mono recording in a state in which the first earbud and a second earbud paired with the first earbud are worn by different users;
identify at least one microphone for the mono recording among the plurality of microphones based on receiving the first data signal;
obtain voice data by applying the filter for the mono recording among the plurality of filters to a voice signal received through the at least one microphone; and
transmit a second data signal indicating the voice data to the external electronic device.

2. The first earbud of claim 1, wherein the instructions, based on being executed by the at least one processor, individually or collectively, cause the first earbud to:
transmit a third data signal indicating the audio data output from the plurality of microphones to the external electronic device; and
identify the filter for the mono recording among the plurality of filters, in response to receiving the first data signal indicating a state identified based on a phase difference between the audio data and the other audio data of the second earbud, by the external electronic device.

3. The first earbud of claim 1, wherein the instructions, based on being executed by the at least one processor, individually or collectively, cause the first earbud to:
transmit a fourth data signal indicating a first vector identified using the acceleration sensor to the external electronic device; and
identify the filter for the mono recording among the plurality of filters based on receiving the first data signal indicating the state identified based on a difference between the first vector and a second vector of the second earbud, exceeding a threshold range, by the external electronic device.

4. The first earbud of claim 1, wherein the instructions, based on being executed by the at least one processor, individually or collectively, cause the first earbud to:
receive the voice signal through the at least one microphone, while identifying a specified vibration using the acceleration sensor.

5. The first earbud of claim 1, wherein the filter for the mono recording is set to remove a frequency band indicating noise included in the voice signal.

6. An electronic device, comprising:
a communication circuit; and
at least one processor comprising a processing circuit; and
memory comprising one or more storage media storing instructions,
wherein the instructions, based on being executed by the at least one processor, individually or collectively, cause the electronic device to:
transmit a first data signal for performing recording to a plurality of wearable devices forming a pair connected through the communication circuit;
receive first audio data of a first wearable device among the plurality of wearable devices and second audio data of a second wearable device among the plurality of wearable devices, based on transmitting the first data signal;
identify a phase difference between the first audio data received from the first wearable device and the second audio data received from the second wearable device exceeding a threshold range;
identify a state of the plurality of wearable devices worn by different users based on identifying the phase difference exceeding the threshold range; and
transmit a third data signal requesting to obtain voice data by applying a filter for mono recording to the plurality of wearable devices, based on identifying the state.

7. The electronic device of claim 6, wherein the instructions, based on being executed by the at least one processor, individually or collectively, cause the electronic device to:
receive a first vector indicating a posture of the first wearable device from the first wearable device;
receive a second vector indicating a posture of the second wearable device from the second wearable device; and
identify the state based on identifying a vector difference of the first vector and the second vector exceeding another threshold range.

8. The electronic device of claim 7, wherein the instructions, based on being executed by the at least one processor, individually or collectively, cause the electronic device to:
identify another state of the plurality of wearable devices worn by the same user based on identifying the vector difference within the threshold range.

9. The electronic device of claim 6, wherein the instructions, based on being executed by the at least one processor, individually or collectively, cause the electronic device to:
transmit the first data signal to the plurality of wearable devices based on execution of a software application providing the recording.

10. The electronic device of claim 6, wherein the instructions, based on being executed by the at least one processor, individually or collectively, cause the electronic device to:
obtain the voice data from the plurality of wearable devices based on transmitting the third data signal.

11. The electronic device of claim 6, wherein the instructions, based on being executed by the at least one processor, individually or collectively, cause the electronic device to:
transmit the third data signal requesting to obtain a voice signal using at least one microphone for the mono recording among a plurality of microphones of the wearable devices.

12. The electronic device of claim 11, wherein the voice signal is obtained through the at least one microphone while a specified vibration is identified through an acceleration sensor of the wearable devices.

13. The electronic device of claim 6, wherein the instructions, based on being executed by the at least one processor, individually or collectively, cause the electronic device to:
obtain the voice data changed from a voice signal indicating a voice of each of the different users from each of the plurality of wearable devices.

14. The electronic device of claim 13, wherein the filter for the mono recording is set to remove a frequency band indicating noise included in the voice signal.

15. A method of an electronic device comprises:
transmitting a first data signal for performing recording to a plurality of wearable devices forming a pair connected through a communication circuit;
receiving first audio data of a first wearable device among the plurality of wearable devices and second audio data of a second wearable device among the plurality of wearable devices, based on transmitting the first data signal;
identifying a phase difference between first audio data received from the first wearable device and the second audio data received from the second wearable device exceeding a threshold range;
identifying a state of the plurality of wearable devices worn by different users based on identifying the phase difference exceeding the threshold range; and
transmitting a third data signal requesting to obtain voice data by applying a filter for mono recording to the plurality of wearable devices, based on identifying the state.

16. The method of claim 15, the identifying of the state of the plurality of wearable devices comprise:
receiving a first vector indicating a posture of the first wearable device from the first wearable device;
receiving a second vector indicating a posture of the second wearable device from the second wearable device; and
identifying the state based on identifying a vector difference of the first vector and the second vector exceeding another threshold range.

17. The method of claim 16, identifying the state of the plurality of wearable devices comprise:
identifying another state of the plurality of wearable devices worn by the same user based on identifying the vector difference within the threshold range.

18. The method of claim 16, wherein the transmitting of the first data signal comprises:
transmitting the first data signal to a plurality of wearable devices based on execution of a software application providing the recording.

19. The method of claim 16, wherein the transmitting of the third data signal comprises:
obtaining the voice data from the plurality of wearable devices based on transmitting the third data signal.

20. The method of claim 16, wherein the transmitting of the third data signal comprises:
transmitting the third data signal requesting the plurality of wearable devices to obtain a voice signal using at least one microphone for the mono recording among the plurality of microphones of the wearable devices.
